(19) United States
(12) Patent Application Publication
(10) Pub. No.: US 2025/0359626 A1
(43) Pub. Date: Nov. 27, 2025

(54) SOLE STRUCTURE FOR AN ARTICLE OF FOOTWEAR

(71) Applicant: NIKE, Inc., Beaverton, OR (US)

(72) Inventors: Austin J. Orand, Portland, OR (US); Aaron K. Seid, Portland, OR (US); Richard Kristian Hansen, Vancouver, WA (US)

(73) Assignee: NIKE, Inc., Beaverton, OR (US)

(21) Appl. No.: 19/209,330

(22) Filed: May 15, 2025

Related U.S. Application Data
(60) Provisional application No. 63/650,530, filed on May 22, 2024.

(51) Int. Cl. A43B 13/18; A43B 13/02; A43B 13/14; B25J 9/00

(52) U.S. Cl. CPC A43B 13/185; A43B 13/026; A43B 13/145; B25J 9/0006

(57) ABSTRACT

A sole structure for an article of footwear may include a unitary, one-piece sole component with a sole plate and a heel support. The sole plate may include a heel region, an inner side facing a foot-receiving side of the sole structure, and an outer side opposite from the inner side and facing a ground contact side of the sole structure. The heel support may include an inner side contiguous with the inner side of the sole plate and an outer side contiguous with the outer side of the sole plate. The heel support may extend around a rear of the heel region and away from the sole plate. The outer side of the heel support may have a convex profile from a medial side to a lateral side of the sole plate.

### CROSS-REFERENCE TO RELATED APPLICATION

This application claims the benefit of priority to U.S. Provisional Application No. 63/650,530, filed May 22, 2024 which is incorporated by reference in its entirety.

### TECHNICAL FIELD

The present disclosure generally relates to a sole structure for an article of footwear. More specifically, a sole structure for an article of footwear disclosed herein may include a unitary, one-piece sole component having a sole plate and a heel support.

### BACKGROUND

Footwear typically includes a sole structure configured to be located under a wearer's foot to space the foot away from the ground. Sole structures may typically be configured to provide one or more of cushioning, motion control, and resiliency.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a perspective view of a unitary, one-piece sole component including a sole plate and a heel support.

FIG. 2 is a rear view of the sole component, showing a through hole.

FIG. 3 is a perspective view of the sole component with a connector assembly mounted at the through hole.

FIG. 4 is a top view of the sole component and the connector assembly.

FIG. 5 is a medial side view of the sole component and the connector assembly.

FIG. 6 is a lateral side view of the sole component and the connector assembly.

FIG. 7 is a cross-sectional view of the sole component and the connector assembly taken at lines 7-7 in FIG. 4.

FIG. 8 is a fragmentary view of a portion of the cross-sectional view of the sole component and connector assembly of FIG. 7 including a close-up view at circle 8A.

FIG. 9 is a perspective view of the connector assembly.

FIG. 10 is a perspective side view of a receptacle of the connector assembly of FIG. 9.

FIG. 11 is a perspective side view of an opposite side of the receptacle of FIG. 9.

FIG. 12 is a view of an outer side of the receptacle of FIG. 10.

FIG. 13 is a view of an inner side of the receptacle of FIG. 10.

FIG. 14 is a perspective view of an inner side of a two-piece retaining ring of the connector assembly including a first retaining component and a second retaining component and showing fasteners securing the first and second retaining components to one another.

FIG. 15 is a perspective view of an outer side of the two-piece retaining ring and fasteners of FIG. 14.

FIG. 16 is a top view of the second retaining component of FIG. 14.

FIG. 17. is a view of the inner side of the second retaining component.

FIG. 18 is a view of the outer side of the second retaining component.

FIG. 19 is a view of the inner side of the first retaining component of FIG. 14.

FIG. 20 is a view of the outer side of the first retaining component of FIG. 14.

FIG. 21 is a bottom view of the first retaining component of FIG. 14.

FIG. 22 is a lateral side view of a sole structure including the sole component and the connector assembly of FIG. 7 and a midsole including a first midsole layer and a second midsole layer, with the sole component disposed between the first midsole layer and the second midsole layer.

FIG. 23 is a top perspective view of the first midsole layer of FIG. 22.

FIG. 24 is a lateral side view of the first midsole layer of FIG. 22.

FIG. 25 is a top perspective view of the second midsole layer of FIG. 22.

FIG. 26 is a rear view of the components of the sole structure shown in FIG. 22.

FIG. 27 is a perspective view of a heel counter.

FIG. 28 is a lateral side view of an article of footwear including the sole structure of FIG. 22, and further showing an outsole, an overlay on the midsole, a footwear upper, and with the heel counter of FIG. 27 in hidden lines.

FIG. 29 is an exploded view of the article of footwear of FIG. 28.

### DESCRIPTION

The present disclosure generally relates to a sole structure for an article of footwear that may include a unitary, one-piece sole component. The unitary, one-piece sole component may include a sole plate and a heel support. The sole plate may include a heel region, an inner side facing a foot-receiving side of the sole structure, and an outer side opposite from the inner side and facing a ground contact side of the sole structure. The heel support may include an inner side contiguous with the inner side of the sole plate and an outer side contiguous with the outer side of the sole plate. The heel support may extend around a rear of the heel region and away from the sole plate. For example, when the unitary, one-piece sole component is positioned with the outer side of the sole plate facing a ground surface, the heel support extends upward, away from the sole plate and the ground surface. The outer side of the heel support may have a convex profile from a medial side to a lateral side of the sole plate.

In an example, the unitary, one-piece sole component may be configured to receive an external force to augment plantar flexion of a wearer's foot. In the same example or in a different example, the unitary, one-piece sole component may be configured for operative connection to an exoskeleton. The terms “external force” and “external load” may be used interchangeably herein. Similarly, the terms “applied force” and “applied load” may be used interchangeably herein.

In an implementation, at a cross-section extending along a longitudinal midline of the unitary, one-piece sole component, the heel support may have a concave curvature at the inner side of the heel support and a convex curvature at the outer side of the heel support.

In an aspect, the unitary, one-piece sole component may comprise a carbon fiber composite material. For example, the carbon fiber composite material may be a thermoset carbon fiber composite material. Forming the unitary, one-piece sole component from such a material may provide a desired combination of relatively light weight and relatively high stiffness enabling the sole component to transfer an applied load with minimal or no flexing.

The unitary, one-piece sole component may include a medial side wall extending from the heel support along the medial side of the sole plate and having a forward end at a medial edge of the sole plate forward of the heel region. In an example, the medial side wall tapers in height from the heel support to the forward end.

In the same example, or in a different example, the unitary, one-piece sole component may include a lateral side wall extending from the heel support along the lateral side of the sole plate and having a forward end at a lateral edge of the sole plate forward of the heel region. The lateral side wall may taper in height from the heel support to the forward end.

In an aspect, the sole plate may be a “full-length” sole plate, meaning that, in addition to the heel region, the sole plate further includes a forefoot region and a midfoot region. A thickness of the sole plate from the inner side of the sole plate to the outer side of the sole plate may be greater in the heel region than in the forefoot region. For example, the thickness of the sole plate may taper from the heel region to the forefoot region. By configuring the sole plate to be thicker in the heel region and by tapering the thickness, a relatively high strength at the heel region may be achieved, such as for distributing loads applied at the heel support, while still maintaining a relatively light weight and not creating stress concentrations.

In the same example or in a different example of a full-length sole plate that includes a forefoot region and a midfoot region in addition to the heel region, a thickness of the heel support from the inner side of the heel support to the outer side of the heel support may be greater than a thickness of the sole plate from the inner side of the sole plate to the outer side of the sole plate in the forefoot region. In other words, the heel support may be relatively thick in order to bear expected loads that may be applied at the heel support and to efficiently transfer the loads to the forefoot region and midfoot region.

In the same example or in a different example of a full-length sole plate that includes a forefoot region and a midfoot region in addition to the heel region, at a cross-section extending along a longitudinal midline of the unitary, one-piece sole component, the sole plate may have a concave curvature at the inner side of the sole plate and a convex curvature at the outer side of the sole plate in the forefoot region. This may provide a relatively “spoon shaped” sole plate, helping to maintain forward momentum until toe-off, for example. In such an implementation, the unitary, one-piece sole component may have a length from a foremost extent of the unitary, one-piece sole component to a rearmost extent of the unitary, one-piece sole component. An apex of the outer side of the sole plate at the cross-section extending along the longitudinal midline of the unitary, one-piece sole component may be at a distance from the foremost extent of the sole component from 25 percent to 45 percent of the length. An apex positioned at this location may efficiently transfer an upward force applied at the heel support to a ground-facing surface below the apex to assist in forward motion when running or walking, for example.

In the same example or in a different example of a full-length sole plate that includes a forefoot region and a midfoot region in addition to the heel region, a minimum width of the unitary, one-piece sole component from a medial edge of the unitary, one-piece sole component to a lateral edge of the unitary, one-piece sole component in the midfoot region may be at least 80 percent of a maximum width of the unitary, one-piece sole component from the medial edge to the lateral edge in the heel region. Configuring the sole plate to maintain such a relatively high ratio of minimum midfoot region width to maximum heel region width may help to maintain a relatively high stiffness and inhibit flexing of the sole plate in response to a load that may be applied at the heel support, and therefore more effectively transferring the applied load to the outer side (bottom) of the sole plate and the ground under the sole structure during plantar flexion.

In an implementation, the heel support may define a through hole extending from the inner side to the outer side. The through hole may be configured for application of an external force to the heel support at the through hole, for example. The through hole may be at least partially aligned with a longitudinal midline of the unitary, one-piece sole component, but is not limited to such a position. Placing the through hole at or near the longitudinal midline may best allow an applied force to be evenly distributed to medial and lateral sides of the sole component.

In the same example or in a different example, the heel support may have a first half and a second half, with the first half closer to the sole plate than the second half. The through hole may be in the second half of the heel support. Positioning the through hole relatively far from the sole plate on the heel support may provide suitable packaging space for a connector assembly to be mounted at the through hole and connected to an exoskeleton without interfering with cushioning and forward movement.

In an implementation, the unitary, one-piece sole component may be sufficiently rigid to prevent flexing of the heel support relative to the sole plate upon application of a force on the heel support at the through hole having a magnitude not greater than a predetermined magnitude.

In the same or a different implementation having a full-length sole plate, the unitary, one-piece sole component may be sufficiently rigid to transfer a force applied to the heel support at the through hole to the outer side of the sole plate in the forefoot region and/or the midfoot region. The material, thickness, sidewalls, etc., of the sole plate are factors in achieving the desired rigidity.

In an implementation, the through hole may have an oval shape. For example, a major axis of the through hole may extend along or parallel with a longitudinal midline of the unitary, one-piece sole component. Furthermore, an edge of the unitary, one-piece sole component at the through hole may have a first semicircular portion adjacent to an edge of the heel support and a second semicircular portion opposite from and symmetrical with the first semicircular portion. In a non-limiting example, the edge at the through hole may include a straight segment extending from the first semicircular portion to the second semicircular portion.

In an example, a receptacle of a connector assembly may be mounted to the unitary, one-piece sole component at the through hole and may define an inlet at least partially aligned with the through hole. Such a receptacle may enable an external load to be applied to the sole component at the receptacle. In an implementation, the receptacle may define a through hole at least partially aligned with the through hole in the sole component, and the inlet of the receptacle may be an inlet of the through hole in the receptacle.

In an aspect, the inlet of the receptacle may be tapered, such as by gradually narrowing from the outer side of the receptacle at the outer side of the sole component inward toward the inner side of the sole component. A non-limiting example of a degree of taper may be about 5 degrees. A tapered inlet provides greater ease in aligning a structure that may be received at the receptacle with the inlet, such as a connector to an exoskeleton for augmented movement of the article of footwear.

In an implementation, the receptacle may include a flange extending around the through hole and against the outer side of the heel support. The flange helps to minimize relative motion of the receptacle and the heel support and distributes loads applied to the receptable more evenly around the through hole, reducing the possibility of stress concentration at the through hole.

In an example, the receptacle is included in a connector assembly. The connector assembly may further include a retaining ring disposed around a neck of the receptacle at an inner side of the heel support, the neck extending through the through hole in the unitary, one-piece sole component. The receptacle may include the flange described herein that extends around the through hole and against the outer side of the heel support. Accordingly, the heel support may be trapped between the flange and the retaining ring, further minimizing relative motion of the receptacle and the heel support and distributing loads applied to the receptable at the through hole more evenly around the through hole.

In an implementation, the retaining ring and the neck of the receptacle may include interfacing ramped surfaces. Accordingly, when the retaining ring is tightened circumferentially around the neck, the ramped surfaces may cause the connector assembly to also tighten in an axial direction, trapping the heel support between the flange of the receptacle and the retaining ring.

In an aspect, the retaining ring may be a two-piece retaining ring including a first retaining component and a second retaining component securable to one another around the neck of the receptacle. In a non-limiting implementation, the neck of the receptacle may include a notch extending through the neck to a through hole in the receptacle, and the second retaining component may include a projection that fits into the notch. These interfitting features of the receptacle and the retaining ring further inhibit relative movement of the heel support and the connector assembly upon application of an external force.

In an example, the sole structure may further include a midsole and the sole plate may be at least partially covered by the midsole. In a non-limiting implementation in which the sole plate is a full-length sole plate, the midsole may include a first midsole layer and a second midsole layer. The first midsole layer may be disposed at the inner side of the sole plate and may extend along the inner side of the heel support. The second midsole layer may be disposed at the outer side of the sole plate and only partially covering the outer side of the of the unitary, one-piece sole component such that the outer side of the unitary, one-piece sole component is exposed in the heel region and in the midfoot region.

In an implementation, the heel support may define a through hole extending from the inner side of the heel support to the outer side of the heel support, and the midsole may define a through hole at least partially aligned with the through hole in the heel support. By providing a through hole in the midsole disposed at least partially in alignment with the through hole in the heel support, any portion of the connector assembly inward of the sole component may be contained within the through hole, spaced away from contact with components inward of the midsole.

In an aspect, the sole structure may include an overlay extending around an outer side of the midsole in the heel region and downward and forward along a medial side of the midsole and along a lateral side of the midsole. The overlay may have a stiffness greater than a stiffness of the midsole. The overlay may thus supplement the stiffness of the heel support in the heel region.

In an implementation, an article of footwear may incorporate the sole structure with any of the features described herein and may further include a footwear upper defining an ankle opening and a foot-receiving cavity at a foot-facing side of the sole structure. The article of footwear may include a heel counter extending around a rear of ankle opening. The footwear upper and the heel counter may be inward of the inner side of the heel support. The heel counter may include a ramp portion at the ankle opening extending downward from the ankle opening toward the foot-receiving cavity. In this manner, entry into the foot-receiving cavity may be made easier as the foot can simply slide in via the ramp portion. The relatively rigid heel support and the heel counter may prevent the heel region of the footwear upper from deforming during foot entry, and the ramp portion utilizes this stiffness by enabling a foot to exert a downward force on the ramp portion and slide forward and downward without collapse of the heel region.

In an aspect, a sole structure for an article of footwear may include a unitary, one-piece sole component having an inner side facing a foot-receiving side of the sole structure and an outer side opposite from the inner side and facing a ground contact side of the sole structure. The unitary, one-piece sole component may define a through hole extending from the inner side to the outer side. A receptacle may be mounted to the unitary, one-piece sole component at the through hole and may define an inlet at least partially aligned with the through hole. The sole structure may further include any of the other features described herein.

Because the unitary, one-piece sole component includes a heel support extending around a rear of the wearer's heel as well as a sole plate extending underfoot, the unitary, one-piece sole component may function to guide movement of the foot. For example, a force applied to the unitary, one-piece sole component is distributed to the sole plate. In some implementations, the heel support may receive externally applied forces to assist the wearer during walking or running, such as to cause rotation of the foot about the ankle, assisting the foot with plantar flexion and reducing the amount of effort required of the wearer compared to performing the same activities without application of such externally applied forces.

Because the heel support and the sole plate are a unitary, one-piece structure, forces applied to the heel support are efficiently distributed by the sole plate. Additionally, the unitary, one-piece sole component may be relatively rigid and, in some implementations, may be more rigid than other components of a sole structure of the article of footwear. For example, the unitary, one-piece sole component may include a carbon fiber composite material, such as a thermoset carbon fiber material. The unitary, one-piece sole component may have a compressive rigidity of a predetermined numerical value or within a predetermined range of numerical values. The unitary, one-piece sole component may be sufficiently rigid to prevent flexing of the heel support relative to the sole plate upon receiving a force not greater than a predetermined force on the heel support. As a result, when a wearer's foot rolls forward in a heel-to-toe direction and plantar flexes through a toe-off position, the unitary, one-piece sole component is sufficiently stiff to maintain forward momentum. Additionally, a relatively stiff unitary, one-piece sole component efficiently converts the applied force to rotation of the unitary, one-piece sole component about the wearer's ankle, for example. The unitary, one-piece sole component establishes a rigidity regardless of the article of footwear in which it is incorporated. For example, when incorporated into an article of footwear, it will increase the rigidity of the sole structure of an otherwise relatively flexible sole structure, establishing at least a baseline rigidity sufficient to convey expected forces applied to the sole component.

In one or more implementations, the unitary, one-piece sole component may be configured to receive an external force to augment plantar flexion of the wearer's foot. For example, the connector assembly or other attachment features discussed herein may be configured to receive and direct an external force on the unitary, one-piece sole component, such as on the heel support, to cause rotation about the ankle, reducing the effort input by the wearer for plantar flexion. This energy assistance may enable the wearer to remain active for longer periods of time and/or to move further distances. In an example, the unitary, one-piece sole component is configured for operative connection to an exoskeleton, with the exoskeleton providing the external force that assists with plantar flexion.

The sole plate itself may also be configured to have various lengths and positions within an article of footwear. For example, the sole plate may be configured to extend only in a heel region of the article of footwear, or may be configured to extend only in a heel region and a midfoot region of the article of footwear, or may be configured to extend in a forefoot region, a midfoot region, and a heel region of the article of footwear.

In one or more examples, the unitary, one-piece sole component may be optimized for lessening added weight while providing sufficient rigidity and strength. By utilizing a relatively lightweight carbon fiber composite material while targeting thickness as needed (e.g., providing sufficient thickness and sidewalls only where necessary and tapering thicknesses and sidewalls in other areas to minimize total weight), the competing goals of lightweight and high strength may be achieved.

The above features and advantages and other features and advantages of the present teachings are readily apparent from the following detailed description of the modes for carrying out the present teachings when taken in connection with the accompanying drawings. It should be understood that even though in the following the embodiments may be separately described, single features thereof may be combined in additional embodiments.

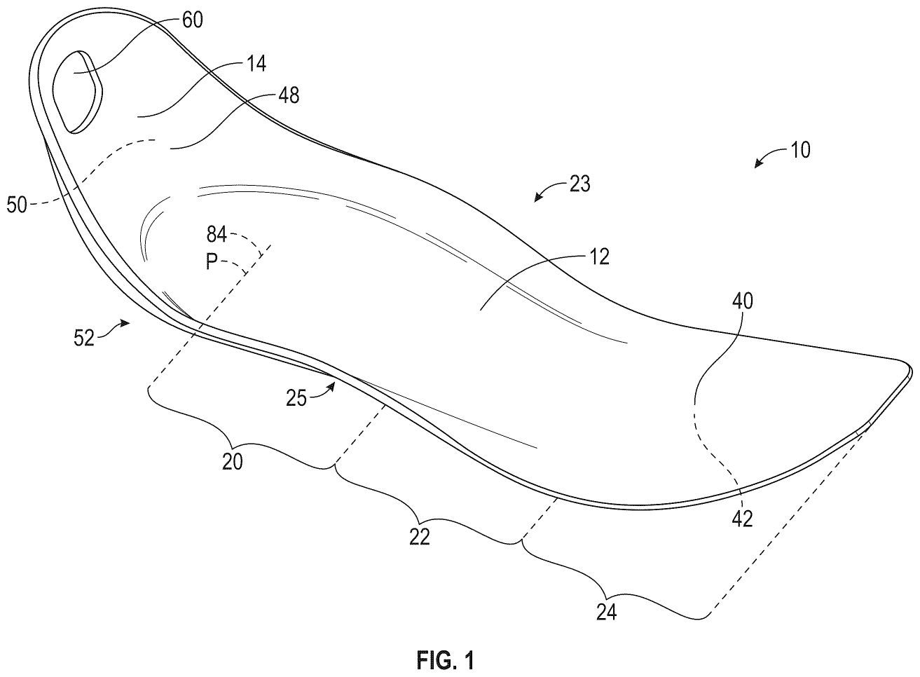

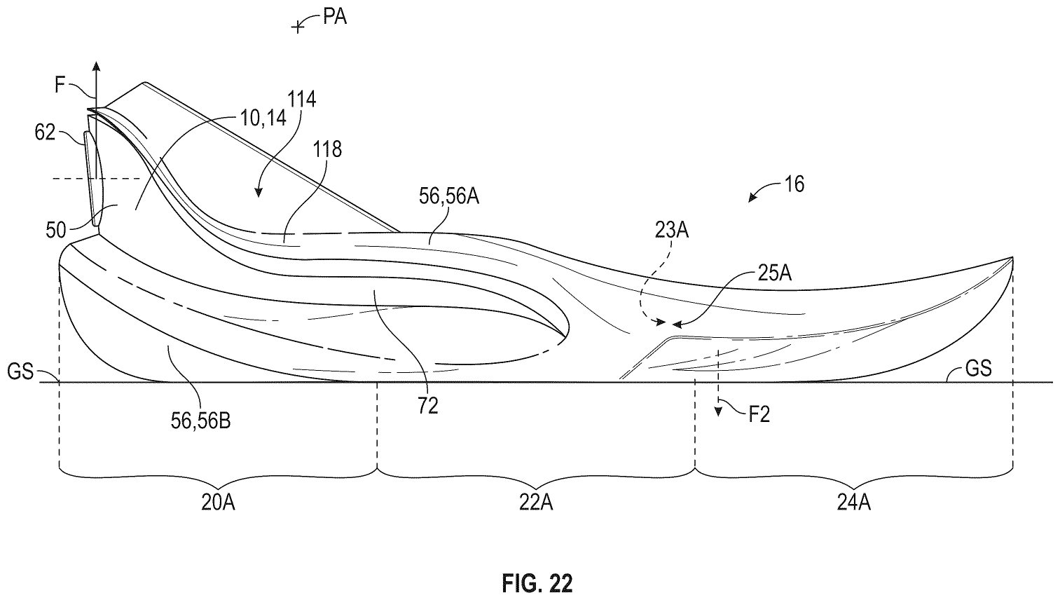

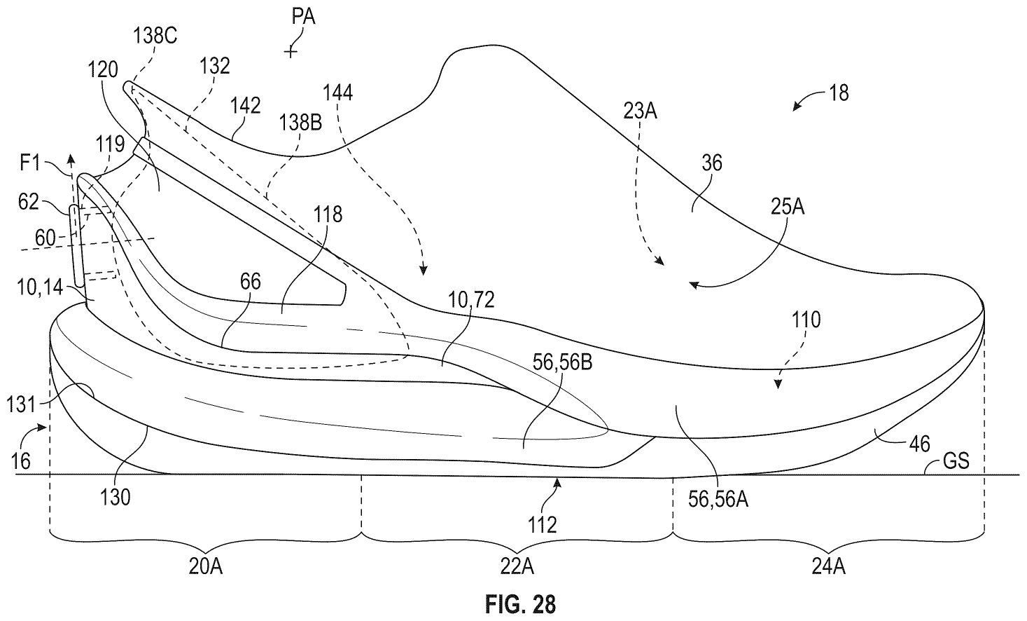

FIG. 1 is a perspective view of a unitary, one-piece sole component 10 including a sole plate 12 and a heel support 14. The one-piece sole component 10 is included in a sole structure for an article of footwear, such as but not limited to the sole structure 16 shown in FIG. 22 and the article of footwear 18 shown in FIG. 28.

The sole plate 12 includes a heel region 20, a midfoot region 22, and a forefoot region 24 and may be referred to herein as a “full length” sole plate. The heel region 20, midfoot region 22, and forefoot region 24 may also be referred to as a heel portion, a midfoot portion, and a forefoot portion of the sole plate 12, respectively, as each is a portion of the unitary sole component 10. The heel region 20, midfoot region 22, and forefoot region 24 of the sole plate 12 generally correspond with a heel region 20A, midfoot region 22A, and forefoot region 24A, respectively, of the sole structure 16 and the article of footwear 18 indicated in FIGS. 22 and 28.

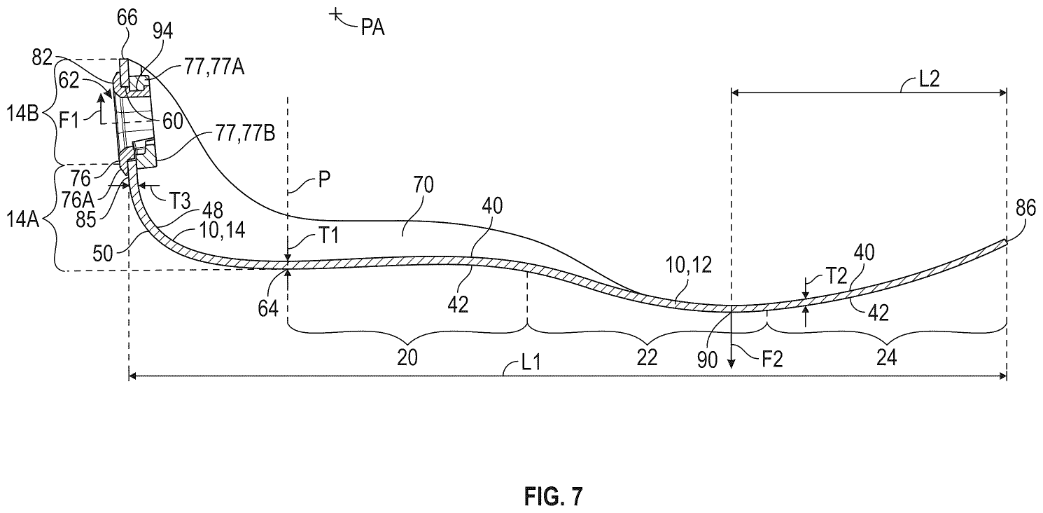

The heel region 20 of the sole plate 12 and the heel region 20A of the sole structure 16 and the article of footwear 18 generally include the portion of the sole plate 12 and the regions of the sole structure 16 and article of footwear 18 that correspond with rear portions of a human foot, including the calcaneus bone, when the human foot of a size corresponding with the sole structure 16 and article of footwear 18 is supported on the sole structure 16. For purposes of discussion herein, the heel region 20 of the sole plate 12 extends only to a plane P at the rearmost extent 84 of the sole plate 12 while the heel region 20A of the sole structure 16 and of the article of footwear 18 also include the heel support 14. The plane P is perpendicular to the longitudinal midline LM and located where a curvature of the outer side 50 changes from linear to nonlinear, as best shown in FIG. 7, for example.

The forefoot region 24 of the sole plate 12 and the forefoot region 24A of the sole structure 16 and the article of footwear 18 generally include the portion of the sole plate 12 and the regions of the sole structure 16 and the article of footwear 18 that correspond with the toes and the joints connecting the metatarsals with the phalanges of the human foot (interchangeably referred to herein as the “metatarsal-phalangeal joints” or “MPJ” joints).

The midfoot region 22 of the sole plate 12 and the midfoot region 22A of the sole structure 16 and the article of footwear 18 is disposed between the heel region 20 and the forefoot region 24, or between the heel region 20A and the forefoot region 24A, respectively, and generally includes the portion of the sole plate 12 and the regions of the sole structure 16 and the article of footwear 18 corresponding with an arch area of the human foot, including the navicular joint.

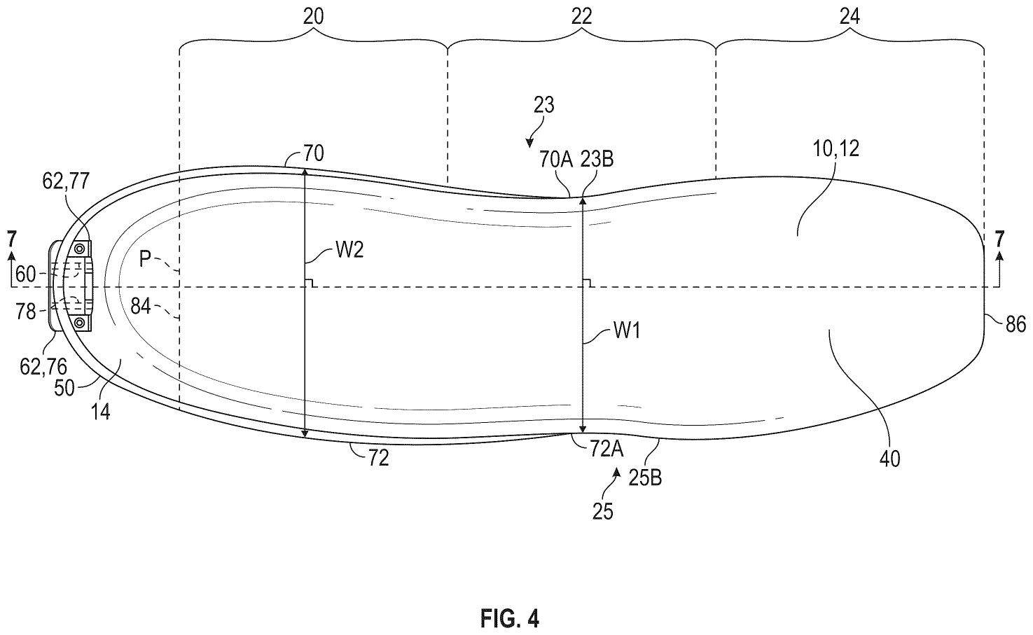

As shown in FIG. 4, the heel region 20 of the sole plate 12 is defined herein as being between planes perpendicular to the longitudinal midline LM and bounding approximately the rear third of the sole plate 12. The midfoot region 22 of the sole plate 12 is defined herein as being between planes perpendicular to the longitudinal midline LM and bounding approximately the middle third of the sole plate 12. The forefoot region 24 of the sole plate 12 is defined herein as being between planes perpendicular to the longitudinal midline LM and bounding approximately the front third of the sole plate 12.

The sole component 10 has a medial side 23 and a lateral side 25 both of which extend from the heel region 20 to the forefoot region 24 and are generally on opposite sides of a longitudinal midline LM of the sole component 10. The longitudinal midline LM is best indicated in FIG. 4. Various example features and aspects of the sole component 10 (e.g., the sole plate 12 and the heel support 14), the sole structure 16, and the article of footwear 18 may be disclosed or explained herein with reference to a “longitudinal direction” and/or with respect to a “longitudinal length” of the sole component 10, sole structure 16, and article of footwear 18. As shown in FIG. 4, the “longitudinal direction” is determined as the direction of the longitudinal midline LM extending from the rearmost extent 84 of the sole plate 12 to a forwardmost extent 86 of the sole component 10 (which is also the foremost extent of the sole plate 12). The longitudinal midline LM may also serve as the longitudinal midline of the sole structure 16 and the article of footwear 18 when the sole component 10 is incorporated therein.

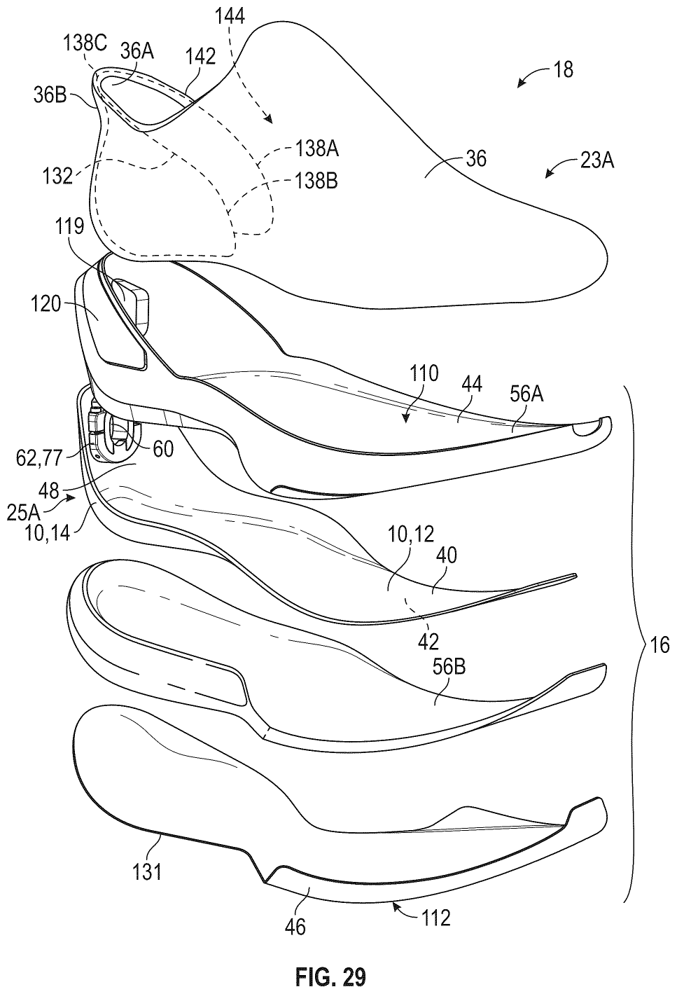

The medial side 23 and the lateral side 25 of the sole component 10 are also referred to as a medial portion and a lateral portion of the sole component 10, respectively. The medial side 23 and the lateral side 25 of the sole component 10 respectively correspond with a medial side 23A and a lateral side 25A of the sole structure 16 and the article of footwear 18 as well as any other components thereof, such as a footwear upper 36 shown in FIGS. 28 and 29. For example, both the footwear upper 36 and the sole structure 16 have a medial side 23A and a lateral side 25A (both of which extend from the heel region 20A to the forefoot region 24A and are generally on opposite sides of the longitudinal midline LM of the article of footwear 18).

The sole plate 12 includes an inner side 40 and an outer side 42 opposite from the inner side 40. The inner side 40 is closer to a foot than the outer side 42 when the article of footwear 18 is worn on a foot. The outer side 42 is further from the foot than the inner side 40. As best indicated in FIG. 29, the inner side 40 faces toward a foot-receiving side 44 of the sole structure 16. The outer side 42 faces toward the outsole 46 and the ground contact side 112 of the sole structure 16.

The heel support 14 includes an inner side 48 contiguous with the inner side 40 of the sole plate 12 and an outer side 50 contiguous with the outer side 42 of the sole plate. Although the heel support 14 and the sole plate 12 are integral portions of the unitary, one-piece sole component 10, for purposes of discussion, the heel support 14 will be considered to be rearward of the plane P. Stated differently, the heel support 14 starts at the plane P and extends rearward from the plane P.

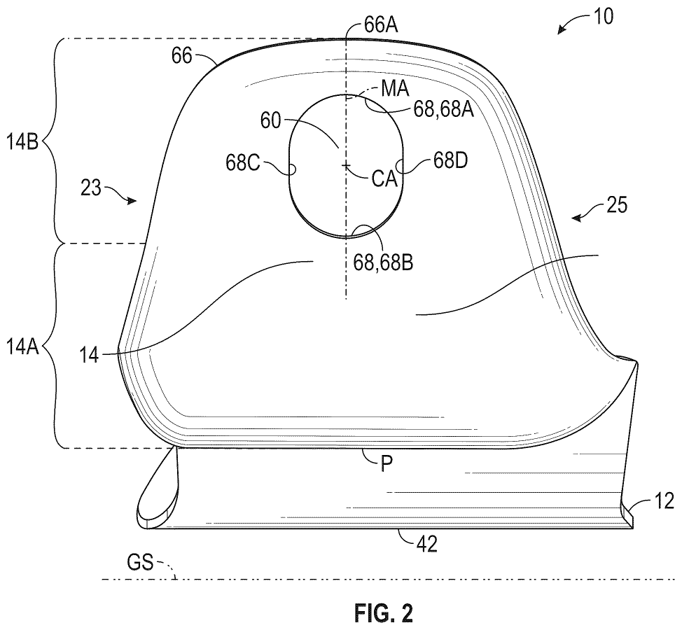

As best indicated in FIGS. 1 and 2, the heel support 14 extends around a rear 52 of the heel region 20 and away from the sole plate 12. For example, when the unitary, one-piece sole component 10 is positioned with the outer side of the sole plate 12 facing a ground surface GS, as in FIG. 22, the heel support 14 extends upward, away from the sole plate 12 and the ground surface GS. The ground surface GS is indicated in phantom in FIG. 2 and also indicated in FIGS. 22 and 28. The ground contact portion of the sole structure 16, such as an outsole 46 indicated in FIGS. 28 and 29, would contact the ground surface GS during walking or running. In FIG. 2, the ground surface GS is shown spaced from the outer side 42 of the sole plate 12 because other components of the sole structure 16 (including the outsole 46 and a portion of a midsole 56 shown in FIGS. 28-29 (e.g., a second midsole layer 56B described herein)) space the sole plate 12 from the ground surface GS.

The unitary, one-piece sole component 10 may be configured to receive an external force to augment plantar flexion of a wearer's foot. This may be accomplished, for example, by operative connection to an exoskeleton. Examples of an exoskeleton used to assist with plantar flexion and improve walking or running performance are found, for example, in United States Patent Application Publication 2023/0124653A1, Farina et al., published Apr. 20, 2023. This energy assistance may enable the wearer to remain active for longer periods of time and/or to move further distances.

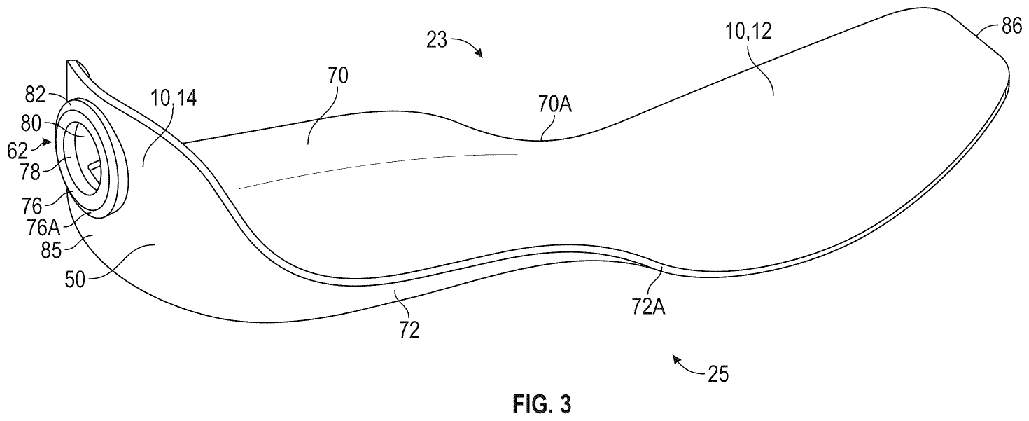

The unitary, one-piece sole component 10 is specifically configured with a through hole 60 defined by the heel support 14 and extending from the inner side 48 to the outer side 50. The through hole 60 may be configured for application of an external force to the heel support 14 at the through hole 60, for example, via a connector assembly 62 mounted at the through hole 60 as shown in FIG. 3 and as further discussed herein. The through hole 60 is shown aligned with the longitudinal midline LM of the unitary, one-piece sole component 10, as best indicated in the views at FIGS. 4, 7, and 8. As used herein, a feature is aligned with the longitudinal midline LM if the feature is intersected by a vertical plane at a cross-section along the longitudinal midline, as in the cross-section shown in FIG. 7, Although shown with the center of the through hole 60 aligned with the longitudinal midline, in other embodiments, the through hole 60 is not limited to such a position, and could be only partially aligned with the longitudinal midline LM (e.g., there being at least some overlap of the through hole 60 with a cross-section taken at the longitudinal midline LM) or even located out of alignment with the longitudinal midline LM. Placing the through hole 60 at or near the longitudinal midline LM may best allow an applied force at the through hole 60 to be evenly distributed to medial and lateral sides 23, 25 of the sole component 10.

With reference to FIGS. 2 and 7, the heel support 14 has a first half 14A and a second half 14B. The first half 14A is measured from the bottom of the heel support 14 (e.g., from the lowermost extent 64 of the outer side 50 which is at the plane P in FIG. 7). The second half 14B is measured an uppermost extent 66A of an edge 66 of the heel support 14. The first half 14A is thus closer to the sole plate 12 than the second half 14B. The through hole 60 is in the second half 14B. Positioning the through hole 60 relatively far from the sole plate 12 on the heel support 14 in this manner enables the connector assembly 62 (and any components connected thereto for delivering an external force) to be packaged in an accessible location at a rear of the sole structure 16 (as shown in FIG. 22) without interfering with space occupied by the midsole layer 56B, for example.

The through hole 60 is shown in FIG. 2 as having an oval shape. Within the scope of the disclosure, the shape of the through hole 60 is not limited to an oval shape and other shapes may be used which may be dictated by a particular connector assembly, if any, mounted at the through hole 60. In the oval example shown, a major axis MA of the through hole 60 extends along or parallel with the longitudinal midline LM (see FIG. 4) of the unitary, one-piece sole component 10 (e.g., the oval shape is positioned with its longer height extending vertically rather than horizontally). Furthermore, an edge 68 of the unitary, one-piece sole component 10 at the through hole 60 has a first semicircular portion 68A adjacent to the edge 66 of the heel support 14 and a second semicircular portion 68B opposite from and symmetrical with the first semicircular portion 68A. The edge 68 at the through hole 60 includes a straight segment 68C extending from the first semicircular portion 68A to the second semicircular portion 68B nearest the medial side 23 and a straight edge 68D extending from the first semicircular portion 68A to the second semicircular portion 68B nearest the lateral side 25.

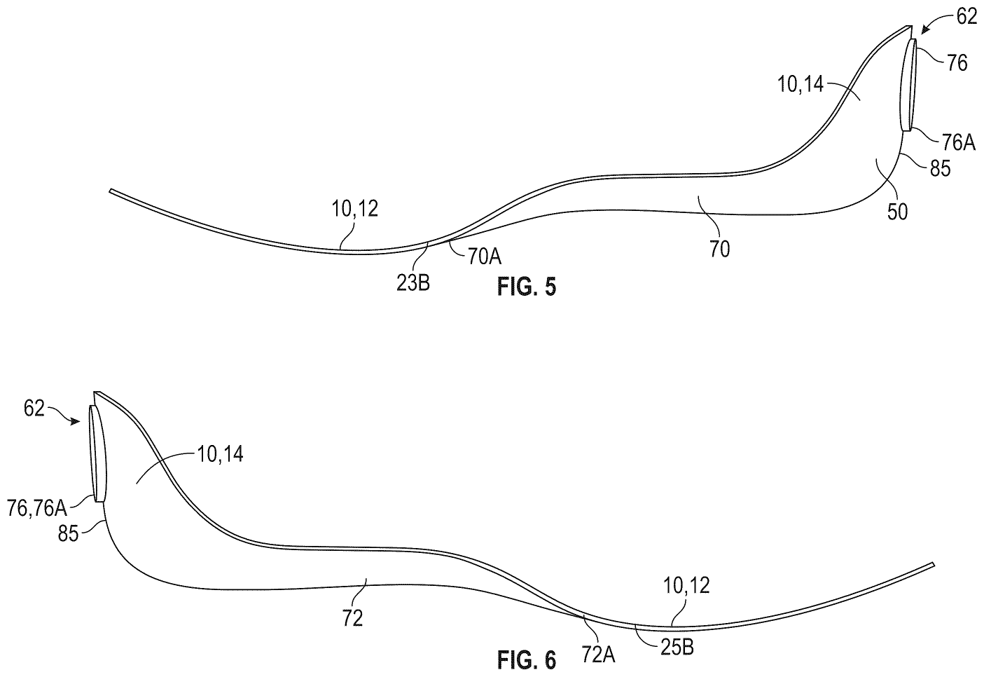

With reference to FIGS. 3-5, the unitary, one-piece sole component 10 includes a medial side wall 70 extending from the heel support 14 along the medial side 23 of the sole plate 12 and having a forward end 70A at a medial edge 23B of the sole plate 12 forward of the heel region 20. The medial side wall 70 tapers in height from the heel support 14 to the forward end 70A.

Similarly, with reference to FIGS. 3-4 and 6, the unitary, one-piece sole component 10 includes a lateral side wall 72 extending from the heel support 14 along the lateral side 25 of the sole plate 12 and having a forward end 72A at a lateral edge 25B of the sole plate 12 forward of the heel region 20. The lateral side wall 72 tapers in height from the heel support 14 to the forward end 72A. Providing side walls 70, 72 may help to strengthen the sole component 10 such as by increasing the bending stiffness (e.g., stiffness with respect to bending along the longitudinal midline LM) and/or increasing the torsional stiffness (e.g., stiffness with respect to twisting about the longitudinal midline LM) of the sole component 10 relative to a sole component configured the same as the sole component 10 except without side walls 70 and 72. This may help to ensure that an external force applied at the through hole 60 via the connector assembly 62 is transferred without loss in magnitude to a portion of the sole plate 12 forward of the side walls 70, 72, such as at the apex 90 discussed with respect to FIG. 7.

FIG. 4 also shows that the outer side 50 of the heel support 14 has a convex profile from the medial side 23 to the lateral side 25 of the sole component 10. FIGS. 2-6 also make this convex profile clear when taken together. Specifically, the outer side 50 has a convex profile along the entire heel support 14, with a rearmost extent 85 falling along the longitudinal midline LM, as indicated in the cross-section of FIG. 7. The outer side 50 curves forward from the rearmost extent 85 to both the medial and lateral sides 23, 25. Such a convex profile may better transfer external loads applied to the sole component 10 at the connector assembly 62 without extreme stress concentrations in comparison to a version in which the profile of the outer side of the heel support was relatively straight from the medial side 23 to the lateral side 25.

Additionally, FIGS. 4 and 7 indicate that, at the cross-section extending along the longitudinal midline LM of the unitary, one-piece sole component 10, the heel support 14 has a concave curvature at the inner side 48 of the heel support 14 and a convex curvature at the outer side 50 of the heel support 14.

FIG. 4 also indicates that a variation in width of the sole component 10 is specifically limited in order to maintain at least a desired bending stiffness and reduce stress concentration when the sole component 10 bears loads, such as when an external load is applied to the sole component 10 at the through hole 60. More specifically, a minimum width W1 of the unitary, one-piece sole component 10 from the medial edge 23B to the lateral edge 25B in the midfoot region 22 of the sole plate 12 is at least 80 percent of a maximum width W2 of the unitary, one-piece sole component 10 from the medial edge 23B to the lateral edge 25B of the sole component 10 in the heel region 20 of the sole plate 12. The widths W1 and W2 are measured perpendicular to the longitudinal midline LM. Configuring the sole component 10 to maintain such a relatively high ratio of minimum midfoot region width to maximum heel region width, as opposed to a narrower width in the midfoot region 22 and therefor a lower ratio, may help to maintain a relatively high stiffness and inhibit flexing of the sole component 10 in response to a load that may be applied at the heel support 14, better transferring the load to the outer side 42 (bottom) of the sole plate 12 and the ground surface GS under the sole structure 16 during plantar flexion, as discussed with respect to FIG. 7.

FIGS. 3 and 4 show that the connector assembly 62 includes a receptacle 76 that is mounted to the unitary, one-piece sole component 10 at the through hole 60. The connector assembly 62 also includes a retaining ring 77 discussed herein that mounts to the receptacle 76 and traps the heel support 14 between the receptacle 76 and the retaining ring 77. The oval shape of the through hole 60 (as opposed to a circular shape, for example) helps to ensure that the receptacle 76 is correctly installed and may also help to prevent rotational motion of the receptacle 76 relative to the heel support.

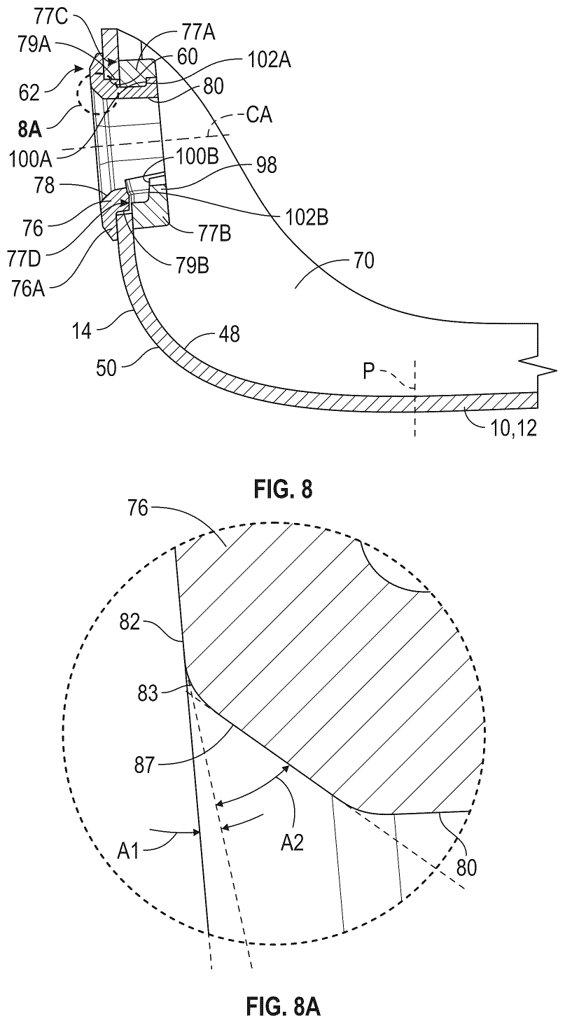

The receptacle 76 defines an inlet 78 at least partially aligned with the through hole 60, as best shown in FIG. 8. The inlet 78 is an inlet of a through hole 80 of the receptacle 76 that is also at least partially aligned with the through hole 60 in the heel support 14 of the sole component 10. As best shown in FIGS. 3 and 8, the receptacle 76 includes a flange 76A extending around the through hole 60 and against the outer side 50 of the heel support 14. The flange 76A helps to minimize relative motion of the receptacle 76 and the heel support 14 and to distribute loads applied to the receptacle 76 more evenly around the through hole 60, reducing the possibility of stress concentration at the through hole 60.

As is best shown in FIG. 8, the inlet 78 of the receptacle 76 is tapered as it gradually narrows from the outer side 82 of the receptacle 76 at the outer side 50 of the sole component (e.g., outer side 50 of the heel support 14) inward toward the inner side of the sole component (e.g., inner side 48 of the heel support 14 as indicated by initial taper angle A1 at surface 83 and secondary taper angle A2 at surface 87). A non-limiting example of the taper angle A1 as shown in circle 8A may be about 5 degrees. The taper angle A2 is larger than the taper angle A1 and may be but is not limited to about 45 degrees. A tapered inlet provides greater ease in aligning a structure that may be received at the receptacle 76 at the inlet 78, such as a connector to an exoskeleton for augmented movement of the article of footwear 18, such as for augmented plantar flexion.

FIG. 7 shows a force F1 representing an external force that may be applied to the sole component 10 at the through hole 60, such as a via an exoskeleton connectable to the connector assembly 62. This force F1 is shown as being directed generally upward, and will cause the sole component 10 (as well as the sole structure 16 and the article of footwear 18 in which it is incorporated) to pivot in a clockwise direction in FIG. 7 about a pivot axis PA, such as at the wearer's ankle, plantar flexing the wearer's foot. This results in a generally downward force F2 transferred through the sole component 10 to the outer side 42 (e.g., the bottom side) of the sole plate 12 at the apex 90.

In an example, the unitary, one-piece sole component 10 is configured for operative connection to an exoskeleton, with the exoskeleton providing the external force F at the connector assembly 62 that assists with plantar flexion. Because the connector assembly 62 is rearward of an axis through the wearer's ankle joint (e.g., pivot axis A indicated in FIG. 7), an upward force on the connector assembly 62 will cause rotation about the ankle joint in a direction consistent with plantar flexion of the wearer's foot. An upward external force applied to the heel support 14, such as force F1 at the connector assembly 62 described herein, should result in forward rotation about the pivot axis A of the ankle shown in FIG. 7 (e.g., plantar flexion), and a resulting downward external force F2 applied by the sole plate 12 (and the sole structure 16) directed toward a flat ground surface GS, such as when the outsole 46 of FIG. 28 is resting on the flat ground surface GS.

The sole component 10 is configured to ensure efficient transfer of the applied external force F1. For example, the sole component 10 is configured to closely follow the contours of a typical foot both at the heel support 14 and at the sole plate 12. For example, at the cross-section extending along the longitudinal midline LM shown in FIG. 7, the heel support 14 has a concave curvature at the inner side 48 of the heel support 14 and a convex curvature at the outer side 50 of the heel support 14. This, in addition to the concave curvature of the heel support 14 at the outer side 50 from the medial side 23 to the lateral side 25, helps the heel support 14 to closely follow the contours of an average foot shape for a foot with a shoe size for which the sole component 10 is configured, enabling the sole component 10 to augment plantar flexion in a manner responsive to the external force F1.

Additionally, at the cross-section shown in FIG. 7 extending along the longitudinal midline LM of the unitary, one-piece sole component 10, the sole plate 12 has a concave curvature at the inner side 40 of the sole plate 12 in the forefoot region 24 and a convex curvature at the outer side 42 of the sole plate 12 in the forefoot region 24. This may provide a relatively “spoon shaped” sole plate 12, helping to maintain forward momentum until toe-off, for example.

The position of the apex 90 of the outer side 42 in the spoon-shaped forefoot region 24 (or in a forward portion of the midfoot region) is also configured to promote efficiency of movement during plantar flexion. For example, the sole component 10 has a length L1 from the foremost extent 86 of the sole component 10 to the rearmost extent 85 of the sole component 10. The apex 90 of the outer side 42 of the sole plate 12 at the cross-section extending along the longitudinal midline LM of the unitary, one-piece sole component 10 is at a distance L2 from the foremost extent 86. The distance L2 is from 25 percent to 45 percent of the length L1. Positioning the apex 90 at this location may most efficiently transfer the upward force F1 applied at the heel support 14 to a ground-facing surface below the apex 90 to assist in forward motion during walking or running, for example.

In addition to the shape of the heel support 14 and the sole plate 12 and position of the apex 90, the relative thicknesses of different portions of the sole component 10 are specifically configured to maintain an overall light weight while meeting strength and stiffness goals. For example, the sole plate 12 has a thickness T1 from the inner side 40 to the outer side 42 in the heel region 20 and a thickness T2 from the inner side 40 to the outer side 42 in the forefoot region 24. The thickness T2 is less than the thickness T1. In fact, the thickness of the sole plate 12 is shown as tapering gradually from the heel region 20 to the forefoot region 24 such that the thickness taken at any part of the heel region 20 is greater than the thickness at any part of the forefoot region 24. By configuring the sole plate 12 to be thicker in the heel region 20 and by tapering the thickness to the forefoot region 24, a desired relatively high strength at the heel region 20 may be achieved, such as for distributing loads applied at the heel support 14, while still maintaining a relatively light weight.

A thickness T3 of the heel support 14 from the inner side 48 of the heel support 14 to the outer side 50 of the heel support 14 may also be greater than the thickness T2 of the sole plate 12 from the inner side 40 of the sole plate 12 to the outer side 42 of the sole plate 12 in the forefoot region 24. For example, the heel support 14 may have the thickness T3 around the through hole 60, which is thicker than the sole plate 12 in the forefoot region 24. In other words, the heel support 14 may be relatively thick to better bear any loads that may be applied at the heel support 14 and efficiently transfer the loads to the forefoot region 24 and midfoot region 22.

The material of the sole component 10, the gradual taper in thickness of the sole plate 12, the presence of the side walls 70, 72, and the relatively high ratio of minimum width W1 of the sole component 10 in the midfoot region 22 to maximum width W2 of the sole component 10 in the heel region 20 are all factors in achieving sufficient strength and avoiding stress concentrations, such as during the augmented plantar flexion discussed herein. With these features, the unitary, one-piece sole component 10 composed of a thermoset carbon fiber composite material may be sufficiently rigid to prevent flexing of the heel support 14 relative to the sole plate 12 upon application of a force such as F1 on the heel support 14 at the through hole 60 having a magnitude not greater than a predetermined magnitude. Accordingly, the one-piece sole component 10 may be sufficiently rigid to transfer a force such as F1 applied to the heel support 14 at the through hole 60 to the outer side 42 of the sole plate 12 in the forefoot region 24 or midfoot region 22. Accordingly, the material, shape (e.g., convex and concave portions as discussed) thickness, width, sidewalls, etc., of the sole component 10 are factors in achieving the desired rigidity.

Because the unitary, one-piece sole component 10 includes a heel support 14 extending around a rear of the wearer's heel as well as a sole plate 12 extending underfoot, the unitary, one-piece sole component 10 may function to guide movement of the foot. For example, a force applied to the unitary, one-piece sole component 10 is distributed to the sole plate 12. In some implementations, the heel support 14 may receive externally applied forces to assist the wearer during walking or running, such as to cause rotation of the foot about the ankle (e.g., about example pivot axis PA indicated in FIGS. 7, 22, and 28), assisting the foot with plantar flexion and reducing the amount of effort required of the wearer compared to performing the same activities without application of such externally applied forces. Because the heel support 14 and the sole plate 12 are a unitary, one-piece structure, any forces applied to the heel support 14 are efficiently distributed by the sole plate 12.

Additionally, the unitary, one-piece sole component 10 may be relatively rigid and, in some implementations, may be more rigid than other components of the sole structure 16 of the article of footwear 18. For example, the unitary, one-piece sole component 10 may include a carbon fiber composite material, such as a thermoset carbon fiber composite material. The unitary, one-piece sole component 10 may have a compressive rigidity of a predetermined numerical value or within a predetermined range of numerical values. The unitary, one-piece sole component 10 may be sufficiently rigid to prevent flexing of the heel support 14 relative to the sole plate 12 upon receiving a force (such as a force applied to the heel support 14 at the through hole 60) not greater than a predetermined force on the heel support 14. As a result, when a wearer's foot rolls forward in a heel-to-toe direction and plantar flexes through a toe-off position, the unitary, one-piece sole component 10 is sufficiently stiff to maintain forward momentum.

Additionally, a relatively stiff unitary, one-piece sole component 10 efficiently converts the applied force to rotation of the unitary, one-piece sole component 10 about the wearer's ankle, for example. The unitary, one-piece sole component 10 establishes a rigidity regardless of the article of footwear 18 in which it is incorporated. For example, when incorporated into an article of footwear 18, it will increase the rigidity of the sole structure 16 of an otherwise relatively flexible sole structure 16, establishing at least a baseline rigidity sufficient to convey expected forces applied to the sole component 10.

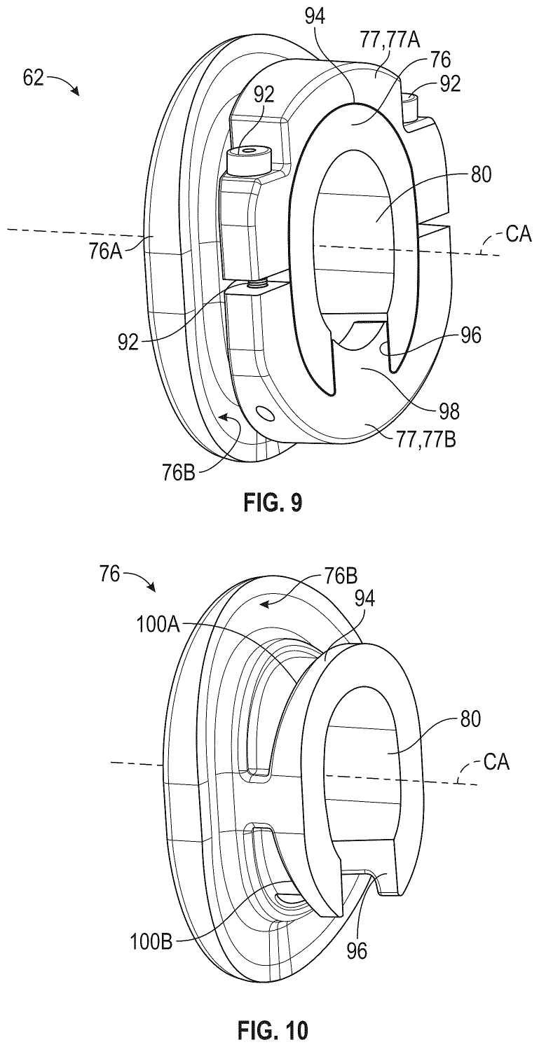

FIG. 9 is a perspective view of the connector assembly 62 including the receptacle 76 and the retaining ring 77. The retaining ring 77 is shown as a two-piece retaining ring including a first retaining component 77A and a second retaining component 77B securable to one another with fasteners 92 around a neck 94 of the receptacle 76. The neck 94 is best shown in FIG. 10. When assembled with the sole component 10, the retaining ring 77 is disposed around the neck 94 of the receptacle 76 at the inner side 48 of the heel support 14, as best shown in FIG. 7, with the neck 94 extending from the flange 76A at the outer side 50 of the heel support 14 and through the through hole 60 in the unitary, one-piece sole component 10. Accordingly, the heel support 14 is trapped between the flange 76A and the retaining ring 77 as shown in FIG. 7, further minimizing relative motion of the receptacle 76 and the heel support 14 and distributing loads applied to the receptacle 76 more evenly around the through hole 60. With reference to FIG. 10, the inner surface 76B of the flange 76A against which the heel support 14 abuts has a contour that matches the curvature of the outer side 50 of the heel support 14 around the through hole 60. As perhaps best shown in FIG. 15, the outer surface 77C of the first retaining component 77A and the outer surface 77D of the second retaining component 77B are both contoured, and together match the contour of the inner side 48 of the heel support 14 against which the retaining components 77A, 77B will abut.

FIG. 10 is a perspective side view of a receptacle 76 of the connector assembly 62 of FIG. 9. The neck 94 of the receptacle 76 includes a notch 96 extending through the neck 94 to the through hole 80 in the receptacle 76. The second retaining component 77B includes a projection 98 that fits into the notch 96 as shown in FIG. 9. These interfitting features of the receptacle 76 and the retaining ring 77 help to further inhibit relative movement of the heel support 14 and the connector assembly 62 upon application of an external force.

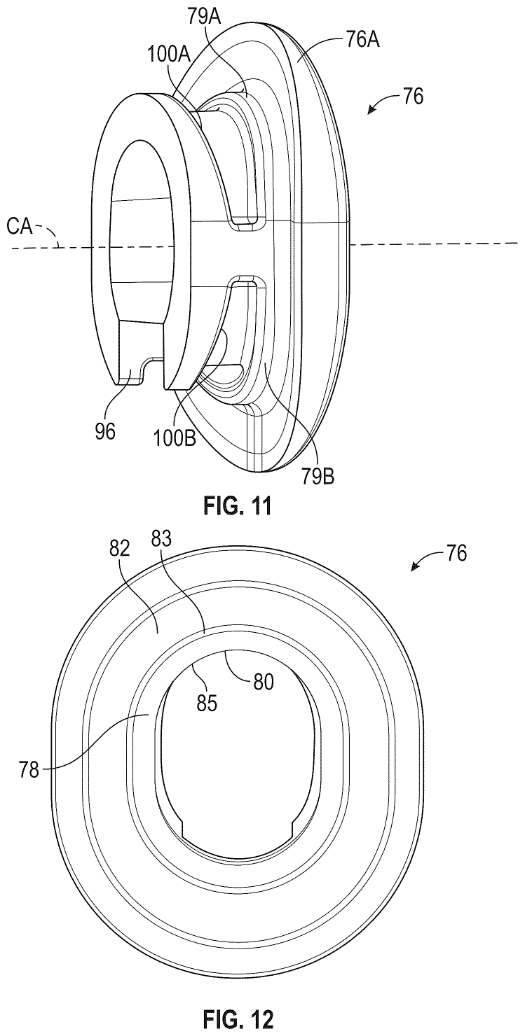

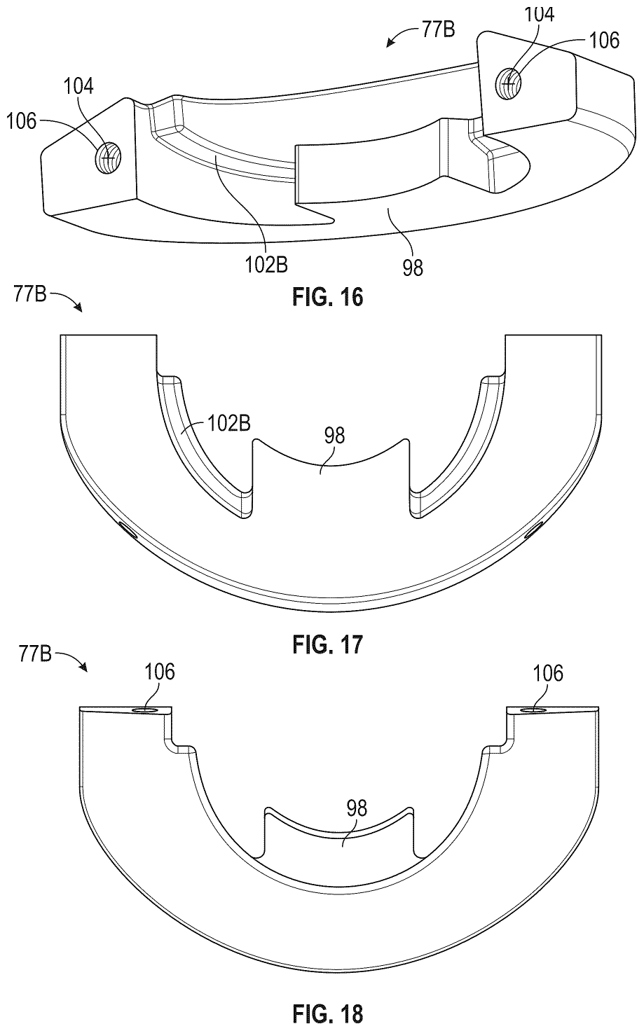

FIGS. 10 and 11 show that the neck 94 has a first ramped surface 100A and a second ramped surface 100B. The ramped surfaces 100A, 100B partially surround the neck 94 and incline in an axial direction of the connector assembly (e.g., in a direction along center axis CA of the connector assembly 62, sloping to the right in FIG. 10). Stated differently, the ramped surfaces 100A, 100B are sloped rather than vertical relative to the center axis CA in FIG. 10. The first retaining component 77A and the second retaining component 77B include ramped surfaces 102A, 102B, respectively, as shown in FIGS. 14-17, for example, that interface with the ramped surfaces 100A and 100B, respectively, of the neck 94 as best shown in FIG. 8. The ramped surface 102A is best shown in FIG. 21 and the ramped surface 102B is best shown in FIG. 16.

The first retaining component 77A and the second retaining component 77B each include two fastener openings 106 that extend completely through the respective retaining components 77A and 77B. The fastener openings 106 of the first retaining component 77A align with the fastener openings 106 of the second retaining component 77B when the retaining components 77A, 77B are mounted on the neck 74. The fastener openings 106 contain the fasteners 92 in the assembled connector assembly 62. The fasteners 92 are externally threaded and the fastener openings 106 are internally threaded in the example shown. The ramped surfaces 102A, 102B do not extend parallel to the center axes 104 of the fastener openings 106 in the assembled connector assembly 62. Accordingly, when the fasteners 92 are tightened in the openings 106, extending from the first retaining component 77A to the second retaining component 77B as shown in FIG. 9, the retaining components 77A, 77B are moved toward one another and, at the same time, move along the ramped surfaces 100A, 100B of the neck 94 in a direction toward the flange 76A. In this manner, the heel support 14 is tightly fit between the flange 76A and the surfaces 77C, 77D of the retaining components 77A, 77B, as best shown in FIG. 8. Stated differently, when the retaining ring 77 is tightened circumferentially around the neck 74 via the fasteners 92, the interfacing ramped surfaces 100A and 102A, and 100B and 102B, cause the connector assembly 62 to also tighten in an axial direction (the axial direction being considered the direction along the center axis CA of the connector assembly 62), trapping the heel support 14 between the flange 76A of the receptacle 76 and the retaining ring 77. Specifically, the heel support 14 is positioned with the through hole 60 around a respective ledge 79A, 79B of the receptacle 76.

The connector assembly 62 is thus specifically configured to mate with the heel support 14 in a manner that minimizes the possibility of relative movement of the connector assembly 62 and the heel support 14 once the connector assembly 62 is tightened on the neck 94.

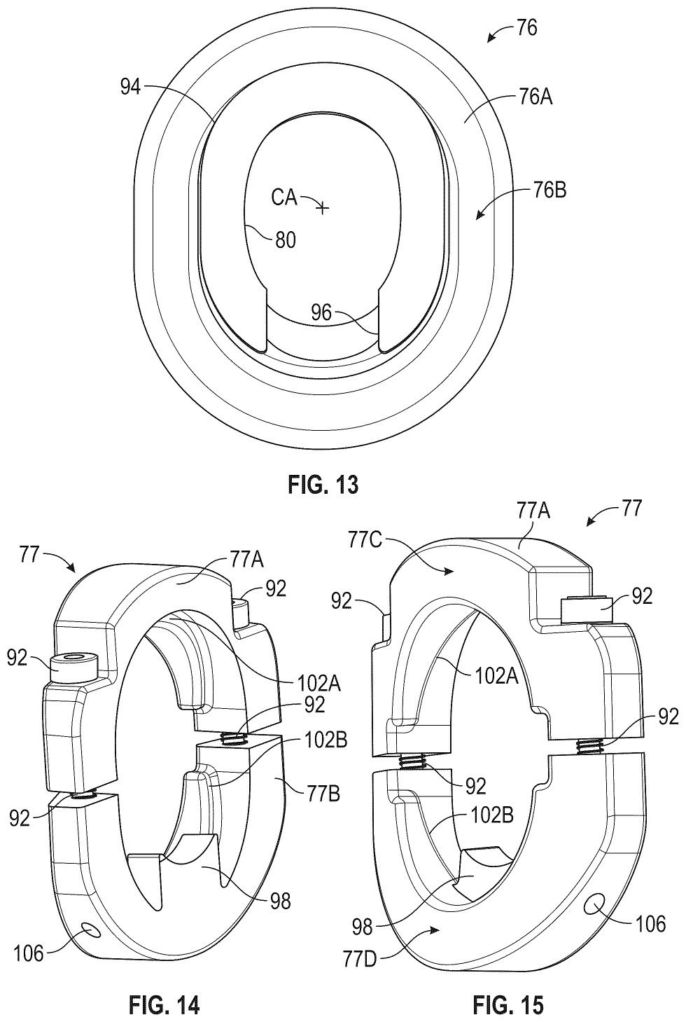

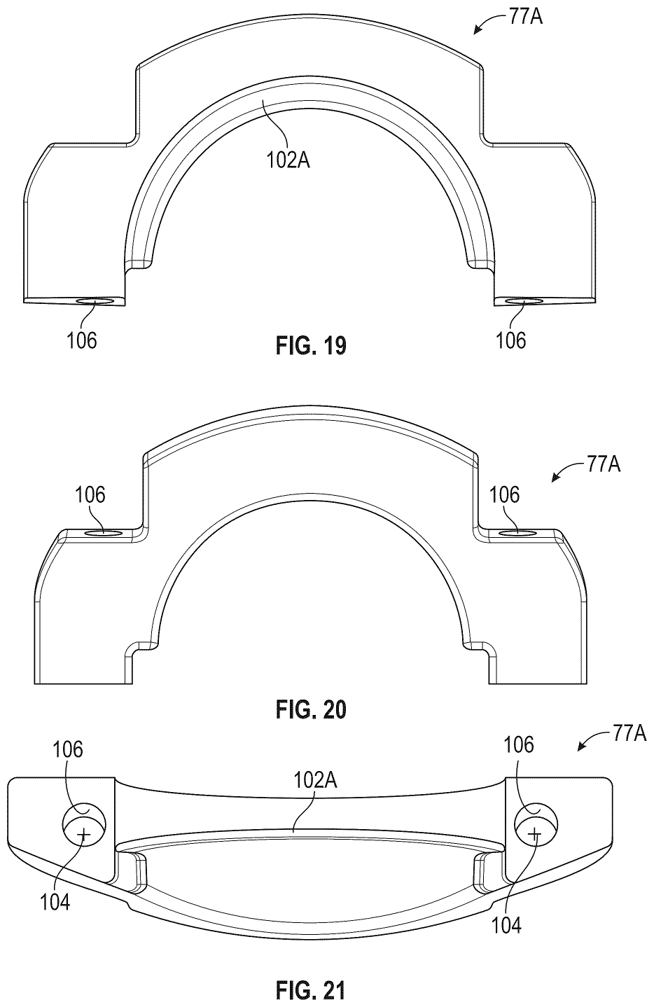

FIG. 12 is a view of an outer side of the receptacle 76 of FIG. 10 and perhaps best shows the tapered inlet 78 as an inlet to the through hole 80. FIG. 13 is a view of an inner side of the receptacle 76 showing the notch 96 and the inner surface 76B of the flange 76A of FIG. 10. FIG. 14 is a perspective view of an inner side of a two-piece retaining ring 77 including the first retaining component 77A and the second retaining component 77B and showing the fasteners 92 securing the first and second retaining components 77A, 77B to one another. FIG. 15 is a perspective view of an outer side of the two-piece retaining ring 77 and fasteners 92 of FIG. 14. FIG. 16 is a top perspective view of the second retaining component 77B of FIG. 14. FIG. 17. is a view of the inner side of the second retaining component 77B and FIG. 18 is a view of the outer side of the second retaining component 77B. FIG. 19 is an inner side view of the first retaining component 77A of FIG. 14 and FIG. 20 is an outer side view of the first retaining component 77A of FIG. 14. FIG. 21 is a bottom view of the first retaining component 77A of FIG. 14.

Although the unitary, one-piece sole component 10 is shown as configured for operative connection to an exoskeleton via the connector assembly 62, in another alternative, the unitary, one-piece sole component 10 may include attachment features configured like any of those disclosed in United States Patent Publication 2023/0124653A1, Farina et al., published Apr. 20, 2023, which is incorporated by reference herein in its entirety.

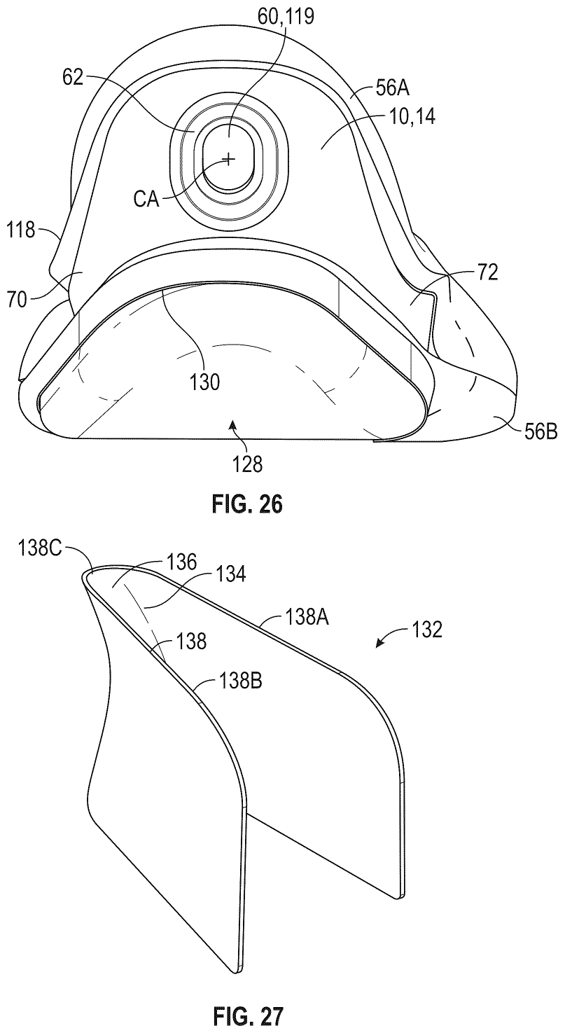

FIG. 22 shows a portion of the sole structure 16, including the midsole 56, with the unitary, one-piece sole component 10 sandwiched between the first midsole layer 56A and the second midsole layer 56B. The outsole 46 shown in FIGS. 28-29 is not shown in FIG. 22. The sole plate 12 shown in FIG. 1 is covered by the midsole 56 in the forefoot region 24 of the sole plate and the corresponding forefoot region 24A of the sole structure 16. The outer side 50 of the heel support 14 as well as the outer side of the lateral side wall 72 is exposed in the heel region 20A, and the outer side of the lateral side wall 72 is partially exposed in the midfoot region 22A, as shown in FIG. 22. The outer side of the medial side wall 70 is also exposed, as is apparent in FIG. 26, for example.

As perhaps best indicated in FIG. 22 and in the exploded view of FIG. 29, the first midsole layer 56A is disposed at the inner side 40 of the sole plate 12 and extends along the inner side 48 of the heel support 14. The second midsole layer 56B is disposed at the outer side 42 of the sole plate 12 and only partially covers the outer side of the unitary, one-piece sole component 10 such that the outer side of the unitary, one-piece sole component is exposed in the heel region 20 of the sole component 10 (e.g., in the heel region 20A of the sole structure 16) and in the midfoot region 22 of the sole component 10 (e.g., in the midfoot region 22A of the sole structure 16). The inner side 40 of the sole plate 12 thus faces a foot-receiving side of the sole structure 16 (e.g., the first midsole layer 56A, a top surface of which may be considered a foot-receiving side at the foot-receiving surface 110 of the sole structure 16, as indicated in FIG. 29). The outer side 42 of the sole plate 12 faces a ground contact side of the sole structure 16 (e.g., the outsole 46, the bottom surface of which may be considered a ground contact side 112 of the sole structure 16).

The sole structure 16 may include additional components not shown in the Figures, such as one or more other sole layers overlaying the first midsole layer 56A or overlaying the sole component 10 between the first midsole layer 56A and the sole component 10, and/or one or more bladders that retain gas. For example, an insole, sockliner, and/or a strobel (not shown) may overlie the foot-receiving surface 110 of the first midsole layer 56A and be disposed between the foot of the wearer and the first midsole layer 56A. The foot-receiving surface 110 of the first midsole layer 56A is shaped to generally cup the shape of the sole of the foot. For example, the foot-receiving surface 110 at the forefoot portion 24A is slightly concave at a transverse cross-section. Additionally, or in the alternative, the material of an insole, such as a foam insole and/or a strobel overlying the foot-receiving surface 110 could be shaped to provide additional geometry between the sole of the wearer's foot and the foot-receiving surface 110 to conform to the sole.

The outsole 46 may be formed from materials that may generally include natural or synthetic rubber or other suitably durable materials. The material or materials for the outsole 46 may be selected to provide a desirable combination of durability and flexibility. Example synthetic rubbers that may be used include polybutadiene rubber, ethylene propylene rubber (EPR), styrene isoprene styrene (SIS) copolymer rubber, and styrene butadiene rubber.

The midsole layers 56A, 56B may be at least partially a polyurethane foam, or a polyurethane ethylene-vinyl acetate (EVA) foam and may include heat-expanded and molded EVA foam pellets. The midsole layers 56A, 56B may generally include phylon (ethylene vinyl acetate or “EVA”) and/or polyurethane (“PU”) base resins. For example, in one embodiment, the midsole layers 56A, 56B may be a compression molded phylon. If EVA is used, it may have a vinyl acetate (VA) level between approximately 9% and approximately 40%. Suitable EVA resins include Elvax®, provided by E. I. du Pont de Nemours and Company, and Engage™, provided by the Dow Chemical Company, for example. In certain embodiments, the EVA may be formed of a combination of high melt index and low melt index material. For example, the EVA may have a melt index of from about 1 to about 50. The EVA resin may be compounded to include various components including a blowing agent and a curing/crosslinking agent. The blowing agent may have a percent weight between approximately 10% and approximately 20%. The blowing agent may be thermally decomposable and is selected from ordinary organic and inorganic chemical blowing agents. The nature of the blowing agent is not particularly limited as long as it decomposes under the temperature conditions used in incorporating the foam into the virgin resin. Suitable blowing agents include azodicarboamide, for example. In certain embodiments, a peroxide-based curing agent, such as dicumyl peroxide may be used. The amount of curing agent may be between approximately 0.6% and approximately 1.5%. The EVA may also include homogenizing agents, process aids, and waxes. For example, a mixture of light aliphatic hydrocarbons such as Struktol® 60NS, available from Schill+Seilacher “Struktol” GmbH, may be included to permit other materials or scrap EVA to be more easily incorporated into the resin. The EVA may also include other constituents such as a release agent (e.g., stearic acid), activators (e.g., zinc oxide), fillers (e.g., magnesium carbonate), pigments, and clays. In embodiments that incorporate multiple materials, each material may be formed from a material that is compatible and readily bonds with the other material. For example, the materials may each be formed from an EVA resin with suitable blowing agents, crosslinking agents, and other ancillary components, pigments, fillers, and the like. Other suitable materials will become readily apparent to those skilled in the art, given the benefit of this disclosure.

The unitary, one-piece sole component may include a carbon fiber composite material that may be a thermoset. Forming the unitary, one-piece sole component from a relatively rigid material enables the unitary, one-piece sole component to distribute forces associated with use of the article of footwear 18 when the article of footwear 18 is in contact with a ground surface. The unitary, one-piece sole component 10 may have a compressive rigidity of a predetermined numerical value or within a predetermined range of numerical values. Other possible materials for the unitary, one-piece sole component include, but are not limited to, a thermoplastic polyurethane, or a polyether block amide PEBAX®, available from Arkema, Inc. in King of Prussia, Pennsylvania USA. The unitary, one-piece sole component may be sufficiently rigid to prevent flexing of the heel support 14 relative to the sole plate 12 upon receiving a force not greater than a predetermined force on the heel support. As a result, when a wearer drops the foot to transition to a toe-off position and plantar flex, the sole plate 12 is sufficiently stiff to maintain forward momentum. Additionally, a relatively stiff unitary, one-piece sole component 10 efficiently converts the applied force to rotate the unitary, one-piece sole component about the wearer's ankle, for example.

The unitary, one-piece sole component 10 may have a greater compressive stiffness as well as a greater bending stiffness than the midsole layers 56A, 56B and/or than the outsole 46 and may be thinner than the midsole layers 56A, 56B. The relative stiffness of the unitary, one-piece sole component 10 enables it to accomplish its functions (e.g., convey forces, encourage forward motion, and enhance stability of the sole structure 16) without unduly increasing the overall thickness (e.g., stack height) of the sole structure 16. A relatively low stack height further enhances stability by maintaining a low ratio of height to width, reducing the propensity for sideways tip.

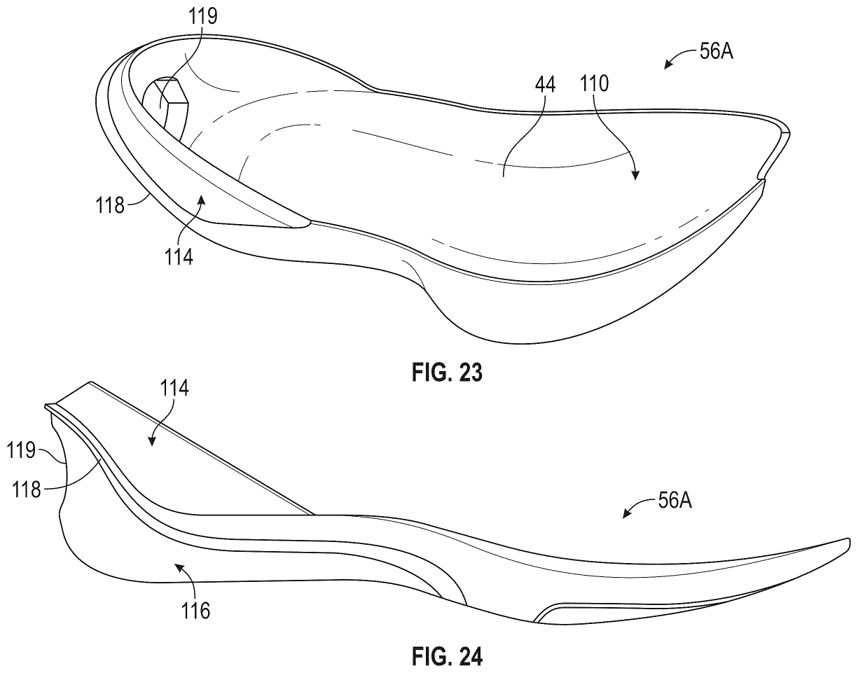

As shown in FIG. 23, the first midsole layer 56A of the midsole 56 defines a through hole 119 extending from the inner side to the outer side of the first midsole layer 56A. The through hole 119 is at least partially aligned with the through hole 60 in the heel support 14 in the assembled article of footwear 18 and is in fact fully aligned with the through hole 60 as perhaps best indicated in FIG. 26, where both through holes 60, 119 share the same center axis which is also the center axis CA of the connector assembly 62. By providing the through hole 119 in the first midsole layer 56A that is disposed at least partially in alignment with the through hole 60 in the heel support 14, the through hole 119 enables any portion of the connector assembly 62 inward of the sole component 10 to be contained within the through hole 119 (e.g., the outer perimeter of the retaining ring 77 is surrounded by the first midsole layer 56A at the through hole 119), and to be spaced away from contact with components inward of the first midsole layer 56A, such as the footwear upper 36.

As shown in FIG. 24, the first midsole layer 56A defines a first outer side surface 114 and a second outer side surface 116 and a ridge 118 separating the first outer side surface 114 and the second outer side surface 116. The ridge 118 extends from the medial side 23A to the lateral side 25A and around a rear of the first midsole layer 56A. An overlay 120 shown in FIGS. 28 and 29 fits against the first outer side surface 114 and extends along and/or fits against an upper side of the ridge 118 in the heel region 20A as shown in FIG. 28. The portion of the overlay 120 on the medial side 23A is generally symmetrical with the portion of the overlay 120 on the lateral side 25A, and the overlay 120 extends around the heel region 20A and downward and forward along the medial side 23A of the first midsole layer 56A and along the lateral side 25A of the first midsole layer 56A. The overlay 120 may have a stiffness greater than a stiffness of the first midsole layer 56A, and may thus help to supplement the stiffness of the heel support 14 in the heel region 20A.

The heel support 14 fits against the second outer surface 116 with the edge 66 of the heel support 14 extending along and/or fitting against a lower side of the ridge 118 as shown in FIG. 28. In this manner, the ridge 118 serves as a locating feature for assembling the sole component 10 and the overlay 120 relative to the first midsole layer 56A.

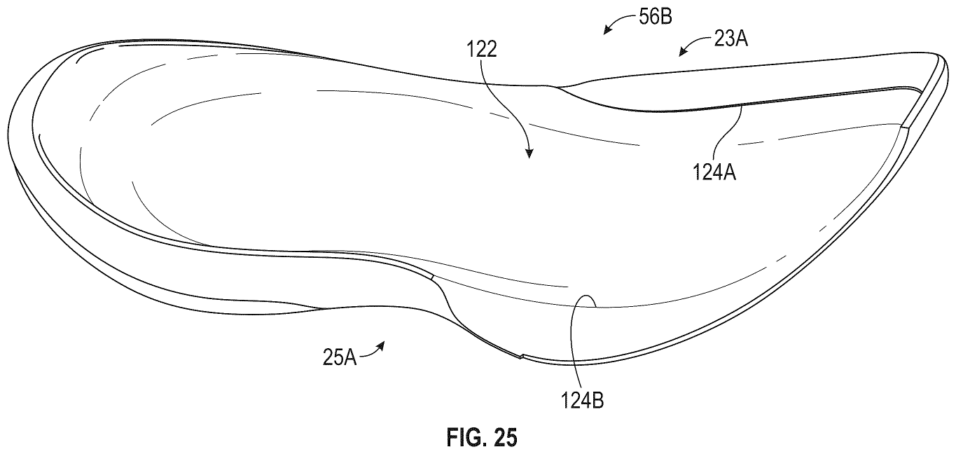

FIG. 25 is a top perspective view of the second midsole layer 56B, showing an inner surface 122, that may also be referred to as a foot-facing side or inner side. A ridge 124A is defined at the inner surface 122 near the medial side 23A. A ridge 124B is defined at the inner surface 122 near the lateral side 25A. The outer side 42 of the sole plate 12 is seated on the inner surface 122 in the assembled sole structure 16 and article of footwear 18 with the ridges 124A and 124B serving as locating features for placing the sole plate 12 on the inner surface 122 between the ridges 124A, 124B.

FIG. 26 is a rear view of the components of the sole structure 16 shown in FIG. 22. An outer surface 128 of the second midsole layer 56B that may also be referred to as an outer side is shown. A ridge 130 is defined and serves as a locating feature for placing the outsole 46 on the outer surface 128 with the ridge extending along or against a peripheral edge 131 of the outsole 46 as shown in FIG. 28.

FIG. 27 is a perspective view of a heel counter 132 included in the article of footwear 18 of FIGS. 28 and 29. More specifically, the heel counter 132 is disposed between an inner layer 36A and an outer layer 36B of the footwear upper 36, as shown in FIGS. 28 and 29 with the heel counter 132 represented with hidden lines. FIG. 27 shows that the heel counter 132 includes an inner side 134 with a ramp portion 136 that extends inward and downward from an upper edge 138 of the heel counter 132. The upper edge 138 has a medial side portion 138A that extends forward and downward and a lateral side portion 138B that also extends forward and downward from a rear extent 138C of the upper edge 138. The heel counter 132 may be a material that is stiffer than the material of the footwear upper 36 as well as stiffer than the first midsole layer 56A. For example, the material of the heel counter 132 may be but is not limited to plastics (such as thermoplastics), composites, and nylon, a polyether block amide such as PEBAX® available from Arkema, Inc. in King of Prussia, Pennsylvania USA, or a fiberglass reinforced polyamide.

As shown in FIGS. 28-29, the footwear upper 36 defines an ankle opening 142 and a foot-receiving cavity 144 at a foot-facing side of the sole structure 16 (e.g., above the foot-receiving surface 110 of the first midsole layer 56A and above the sole plate 12). When assembled between the layers 36A, 36B of the footwear upper 36, the heel counter 132 extends around a rear of the ankle opening 142 with the upper edge 138 following the ankle opening 142 at the rear of the ankle opening 142 and with the footwear upper 36 and the heel counter 132 inward of the inner side 48 of the heel support 14. The ramp portion 136 extends forward and downward from the rear of the ankle opening 142 toward the foot-receiving cavity 144. In this manner, entry into the foot-receiving cavity 144 is made easier as the foot can simply slide downward and forward into the foot-receiving cavity 144 via the ramp portion 136. The relatively rigid heel support 14 and the heel counter 132 may prevent the heel region 20A of the footwear upper 36 from deforming during foot entry, and the ramp portion 136 utilizes this stiffness by enabling a foot to exert a downward force on the ramp portion 136 and slide forward and downward without collapse of the heel region 20A.

Accordingly, a unitary, one-piece sole component 10 as described herein can effectively and efficiently transmit forces intended to assist with motion of the foot. In some implementations, the unitary, one-piece sole structure may receive forces to assist the wearer during walking or running, such as to cause rotation of the foot about the ankle, assisting the foot with plantar flexion and reducing the effort of the wearer. The connector assembly 62 is configured to help ensure efficient delivery of an applied force to the sole component 10 without lost motion (e.g., movement of the connector assembly 62 relative to the sole component 10). An upward force applied to the unitary, one-piece sole component 10 at the heel support 14 may act to rotate the article of footwear 18 about a pivot axis PA at the ankle, pushing at least a portion of the sole plate 12 downward during plantar flexion.

The following Clauses provide example configurations of a sole structure for an article of footwear disclosed herein.
Clause 1. A sole structure for an article of footwear, the sole structure comprising: a unitary, one-piece sole component, wherein the unitary, one-piece sole component includes a sole plate and a heel support; wherein the sole plate includes a heel region, an inner side facing a foot-receiving side of the sole structure, and an outer side opposite from the inner side and facing a ground contact side of the sole structure; wherein the heel support includes an inner side contiguous with the inner side of the sole plate and an outer side contiguous with the outer side of the sole plate, and the heel support extends around a rear of the heel region and away from the sole plate; and wherein the outer side of the heel support has a convex profile from a medial side to a lateral side of the sole plate.
Clause 2. The sole structure of Clause 1, wherein, at a cross-section extending along a longitudinal midline of the unitary, one-piece sole component, the heel support has a concave curvature at the inner side of the heel support and a convex curvature at the outer side of the heel support.
Clause 3. The sole structure of any of Clauses 1-2, wherein the unitary, one-piece sole component comprises a carbon fiber composite material.
Clause 4. The sole structure of Clause 3, wherein the carbon fiber composite material is a thermoset carbon fiber composite material.
Clause 5. The sole structure of any of Clauses 1-2, wherein the unitary, one-piece sole component includes a medial side wall extending from the heel support along the medial side of the sole plate and having a forward end at a medial edge of the sole plate forward of the heel region.
Clause 6. The sole structure of any of Clauses 1-2, wherein the unitary, one-piece sole component includes a medial side wall extending from the heel support along the medial side of the sole plate and having a forward end at a medial edge of the sole plate, the medial side wall tapering in height from the heel support to the forward end.
Clause 7. The sole structure of any of Clauses 1-2, wherein the unitary, one-piece sole component includes a lateral side wall extending from the heel support along the lateral side of the sole plate and having a forward end at a lateral edge of the sole plate forward of the heel region.
Clause 8. The sole structure of any of Clauses 1-2, wherein the unitary, one-piece sole component includes a lateral side wall extending from the heel support along the lateral side of the sole plate and having a forward end at a lateral edge of the sole plate, the lateral side wall tapering in height from the heel support to the forward end.
Clause 9. The sole structure of any of Clauses 1-2, wherein: the sole plate further includes a forefoot region and a midfoot region; and a thickness of the sole plate from the inner side of the sole plate to the outer side of the sole plate is greater in the heel region than in the forefoot region.
Clause 10. The sole structure of Clause 9, wherein the thickness of the sole plate tapers from the heel region to the forefoot region.
Clause 11. The sole structure of any of Clauses 1-2, wherein: the sole plate further includes a forefoot region and a midfoot region; and a thickness of the heel support from the inner side of the heel support to the outer side of the heel support is greater than a thickness of the sole plate from the inner side of the sole plate to the outer side of the sole plate in the forefoot region.
Clause 12. The sole structure of any of Clauses 1-2, wherein: the sole plate further includes a forefoot region and a midfoot region; and at a cross-section extending along a longitudinal midline of the unitary, one-piece sole component, the sole plate has a concave curvature at the inner side of the sole plate and a convex curvature at the outer side of the sole plate in the forefoot region.
Clause 13. The sole structure of Clause 12, wherein: the unitary, one-piece sole component has a length from a foremost extent of the unitary, one-piece sole component to a rearmost extent of the unitary, one-piece sole component; and an apex of the outer side of the sole plate at the cross-section extending along the longitudinal midline of the unitary, one-piece sole component is at a distance from the foremost extent of the sole plate of from 25 percent to 45 percent of the length.
Clause 14. The sole structure of any of Clauses 1-2, wherein: the sole plate further includes a forefoot region and a midfoot region; and a minimum width of the unitary, one-piece sole component from a medial edge of the unitary, one-piece sole component to a lateral edge of the unitary, one-piece sole component in the midfoot region is at least 80 percent of a maximum width of the unitary, one-piece sole component from the medial edge of the unitary, one-piece sole component to the lateral edge of the unitary, one-piece sole component in the heel region.
Clause 15. The sole structure of any of Clauses 1-2, wherein the heel support defines a through hole extending from the inner side to the outer side.
Clause 16. The sole structure of Clause 15, wherein the through hole is at least partially aligned with a longitudinal midline of the unitary, one-piece sole component.
Clause 17. The sole structure of Clause 15, wherein: the heel support has a first half and a second half, the first half closer to the sole plate than the second half; and the through hole is in the second half of the heel support.
Clause 18. The sole structure of Clause 15, wherein the through hole has an oval shape.
Clause 19. The sole structure of Clause 18, wherein a major axis of the through hole extends along or parallel with a longitudinal midline of the unitary, one-piece sole component.
Clause 20. The sole structure of Clause 15, wherein the unitary, one-piece sole component has an edge at the through hole that has a first semicircular portion adjacent to an edge of the heel support and a second semicircular portion opposite from and symmetrical with the first semicircular portion.
Clause 21. The sole structure of Clause 20, wherein the edge at the through hole includes a straight segment extending from the first semicircular portion to the second semicircular portion.
Clause 22. The sole structure of Clause 15, further comprising: a receptacle mounted to the unitary, one-piece sole component at the through hole and defining an inlet at least partially aligned with the through hole.
Clause 23. The sole structure of Clause 22, wherein the receptacle defines a through hole at least partially aligned with the through hole in the sole component, and the inlet of the receptacle is an inlet of the through hole in the receptacle.
Clause 24. The sole structure of Clause 22, wherein the inlet is tapered.
Clause 25. The sole structure of Clause 22, wherein the receptacle includes a flange extending around the through hole and against the outer side of the heel support.
Clause 26. The sole structure of Clause 22, wherein the receptacle is included in a connector assembly, the connector assembly further including a retaining ring disposed around a neck of the receptacle at an inner side of the heel support, the neck extending through the through hole in the unitary, one-piece sole component.
Clause 27. The sole structure of Clause 26, wherein: the receptacle includes a flange extending around the through hole and against the outer side of the heel support; and the heel support is trapped between the flange and the retaining ring.
Clause 28. The sole structure of Clause 26, wherein the retaining ring and the neck of the receptacle include interfacing ramped surfaces.
Clause 29. The sole structure of Clause 26, wherein the retaining ring is a two-piece retaining ring including a first retaining component and a second retaining component securable to one another around the neck of the receptacle.
Clause 30. The sole structure of Clause 29, wherein: the neck of the receptacle includes a notch extending through the neck to a through hole in the receptacle; and the second retaining component includes a projection that fits into the notch.
Clause 31. The sole structure of any of Clauses 1-2, wherein: the heel support defines a through hole extending from the inner side to the outer side; and the unitary, one-piece sole component is sufficiently rigid to prevent flexing of the heel support relative to the sole plate upon application of a force on the heel support at the through hole having a magnitude not greater than a predetermined magnitude.
Clause 32. The sole structure of any of Clauses 1-2, wherein: the heel support defines a through hole extending from the inner side to the outer side; the sole plate further includes a forefoot region and a midfoot region; and the unitary, one-piece sole component is sufficiently rigid to transfer a force applied to the heel support at the through hole to the outer side of the sole plate in the forefoot region and/or the midfoot region.
Clause 33. The sole structure of any of Clauses 1-2, further comprising: a midsole; wherein the sole plate is at least partially covered by the midsole.
Clause 34. The sole structure of Clause 33, wherein: the sole plate further includes a forefoot region and a midfoot region; and the midsole includes: a first midsole layer disposed at the inner side of the sole plate and extending along the inner side of the heel support; and a second midsole layer disposed at the outer side of the sole plate and only partially covering the outer side of the of the unitary, one-piece sole component such that the outer side of the unitary, one-piece sole component is exposed in the heel region and in the midfoot region.
Clause 35. The sole structure of Clause 33, wherein: the heel support defines a through hole extending from the inner side of the heel support to the outer side of the heel support; and the midsole defines a through hole at least partially aligned with the through hole in the heel support.
Clause 36. The sole structure of Clause 33, further comprising: an overlay extending around an outer side of the midsole in the heel region and extending downward and forward along a medial side of the midsole and along a lateral side of the midsole; wherein the overlay has a stiffness greater than a stiffness of the midsole.
Clause 37. The sole structure of any of Clauses 1-2, wherein the unitary, one-piece sole component is configured to receive an external force to augment plantar flexion of a wearer's foot.
Clause 38. The sole structure of any of Clauses 1-2, wherein the unitary, one-piece sole component is configured for operative connection to an exoskeleton.
Clause 39. An article of footwear incorporating the sole structure of any of Clauses 1-2, wherein the article of footwear includes: a footwear upper defining an ankle opening and a foot-receiving cavity at a foot-facing side of the sole structure; and a heel counter extending around a rear of ankle opening; wherein the footwear upper and the heel counter are inward of the inner side of the heel support.
Clause 40. The article of footwear of Clause 39, wherein the heel counter has a ramp portion at the ankle opening extending downward from the ankle opening toward the foot-receiving cavity.
Clause 41. A sole structure for an article of footwear, the sole structure comprising: a unitary, one-piece sole component having an inner side facing a foot-receiving side of the sole structure and an outer side opposite from the inner side and facing a ground contact side of the sole structure; wherein the unitary, one-piece sole component defines a through hole extending from the inner side to the outer side; and a receptacle mounted to the unitary, one-piece sole component at the through hole and defining an inlet at least partially aligned with the through hole.
Clause 42. The sole structure of Clause 41, wherein the receptacle defines a through hole at least partially aligned with the through hole in the sole component, and the inlet of the receptacle is an inlet of the through hole in the receptacle.
Clause 43. The sole structure of any of Clauses 41-42, wherein the inlet is tapered.
Clause 44. The sole structure of any of Clauses 41-42, wherein the receptacle includes a flange extending around the through hole in the unitary, one-piece sole component and against the outer side of the unitary, one-piece sole component.
Clause 45. The sole structure of any of Clauses 41-42, wherein the receptacle is included in a connector assembly, the connector assembly further including a retaining ring disposed around a neck of the receptacle at an inner side of the unitary, one-piece sole component, the neck extending through the through hole in the unitary, one-piece sole component.
Clause 46. The sole structure of Clause 45, wherein: the receptacle includes a flange extending around the through hole and against the outer side of the unitary, one-piece sole component; and the unitary, one-piece sole component is trapped between the flange and the retaining ring.
Clause 47. The sole structure of Clause 45, wherein the retaining ring and the neck of the receptacle include interfacing ramped surfaces.
Clause 48. The sole structure of Clause 45, wherein the retaining ring is a two-piece retaining ring including a first retaining component and a second retaining component securable to one another around the neck of the receptacle.
Clause 49. The sole structure of Clause 45, wherein: the neck of the receptacle includes a notch extending through the neck to a through hole in the receptacle; and the retaining ring includes a projection that fits into the notch.
Clause 50. The sole structure of any of Clauses 41-42, wherein the unitary, one-piece sole component includes a sole plate having a heel region, a midfoot region, and a forefoot region.
Clause 51. The sole structure of Clause 50, wherein the unitary, one-piece sole component is thicker around the through hole than in the forefoot region.
Clause 52. The sole structure of any of Clauses 41-42, wherein the unitary, one-piece sole component comprises a carbon fiber composite material.
Clause 53. The sole structure of Clause 52, wherein the carbon fiber composite material is a thermoset carbon fiber composite material.

To assist and clarify the description of various embodiments, various terms are defined herein. Unless otherwise indicated, the following definitions apply throughout this specification (including the claims). Additionally, all references referred to are incorporated herein in their entirety.

An “article of footwear”, a “footwear article of manufacture”, and “footwear” may be considered to be both a machine and a manufacture. Assembled, ready to wear footwear articles (e.g., shoes, sandals, boots, etc.), as well as discrete components of footwear articles (such as a midsole, an outsole, an upper component, etc.) prior to final assembly into ready to wear footwear articles, are considered and alternatively referred to herein in either the singular or plural as “article(s) of footwear”.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

The term “longitudinal” particularly refers to a direction extending a length of a component. For example, a longitudinal direction of a shoe extends between a forefoot region and a heel region of the shoe. The term “forward” or “anterior” is used to particularly refer to the general direction from a heel region toward a forefoot region, and the term “rearward” or “posterior” is used to particularly refer to the opposite direction, i.e., the direction from the forefoot region toward the heel region. In some cases, a component may be identified with a longitudinal axis as well as a forward and rearward longitudinal direction along that axis. The longitudinal direction or axis may also be referred to as an anterior-posterior direction or axis.

The term “transverse” particularly refers to a direction extending a width of a component. For example, a transverse direction of a shoe extends between a lateral side and a medial side of the shoe. The transverse direction or axis may also be referred to as a lateral direction or axis or a mediolateral direction or axis.

The term “vertical” particularly refers to a direction generally perpendicular to both the lateral and longitudinal directions. For example, in cases where a sole structure is planted flat on a ground surface, the vertical direction may extend from the ground surface upward. It will be understood that each of these directional adjectives may be applied to individual components of a sole structure. The term “upward” or “upwards” particularly refers to the vertical direction pointing towards a top of the component, which may include an instep, a fastening region and/or a throat of an upper. The term “downward” or “downwards” particularly refers to the vertical direction pointing opposite the upwards direction, toward the bottom of a component and may generally point towards the bottom of a sole structure of an article of footwear.

The “interior” of an article of footwear, such as a shoe, particularly refers to portions at the space that is occupied by a wearer's foot when the shoe is worn. The “inner side” of a component particularly refers to the side or surface of the component that is (or will be) oriented toward the interior of the component or article of footwear in an assembled article of footwear. The “outer side” or “exterior” of a component particularly refers to the side or surface of the component that is (or will be) oriented away from the interior of the shoe in an assembled shoe. In some cases, other components may be between the inner side of a component and the interior in the assembled article of footwear. Similarly, other components may be between an outer side of a component and the space external to the assembled article of footwear. Further, the terms “inward” and “inwardly” particularly refer to the direction toward the interior of the component or article of footwear, such as a shoe, and the terms “outward” and “outwardly” particularly refer to the direction toward the exterior of the component or article of footwear, such as the shoe. In addition, the term “proximal” particularly refers to a direction that is nearer a center of a footwear component, or is closer toward a foot when the foot is inserted in the article of footwear as it is worn by a user. Likewise, the term “distal” particularly refers to a relative position that is further away from a center of the footwear component or is further from a foot when the foot is inserted in the article of footwear as it is worn by a user. Thus, the terms proximal and distal may be understood to provide generally opposing terms to describe relative spatial positions.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

While several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A sole structure for an article of footwear, the sole structure comprising:
a unitary, one-piece sole component, wherein the unitary, one-piece sole component includes a sole plate and a heel support;
wherein the sole plate includes a heel region, an inner side facing a foot-receiving side of the sole structure, and an outer side opposite from the inner side;
wherein the heel support includes an inner side contiguous with the inner side of the sole plate and an outer side contiguous with the outer side of the sole plate, and the heel support extends around a rear of the heel region and away from the sole plate; and
wherein the outer side of the heel support has a convex profile from a medial side to a lateral side of the sole plate.

2. The sole structure of claim 1, wherein, at a cross-section extending along a longitudinal midline of the unitary, one-piece sole component, the heel support has a concave curvature at the inner side of the heel support and a convex curvature at the outer side of the heel support.

3. The sole structure of claim 1, wherein the unitary, one-piece sole component comprises a carbon fiber composite material.

4. The sole structure of claim 1, wherein the unitary, one-piece sole component includes a medial side wall extending from the heel support along the medial side of the sole plate and having a forward end at a medial edge of the sole plate forward of the heel region.

5. The sole structure of claim 1, wherein the unitary, one-piece sole component includes a medial side wall extending from the heel support along the medial side of the sole plate and having a forward end at a medial edge of the sole plate, the medial side wall tapering in height from the heel support to the forward end.

6. The sole structure of claim 1, wherein the unitary, one-piece sole component includes a lateral side wall extending from the heel support along the lateral side of the sole plate and having a forward end at a lateral edge of the sole plate forward of the heel region.

7. The sole structure of claim 1, wherein the unitary, one-piece sole component includes a lateral side wall extending from the heel support along the lateral side of the sole plate and having a forward end at a lateral edge of the sole plate, the lateral side wall tapering in height from the heel support to the forward end.

8. The sole structure of claim 1, wherein:
the sole plate further includes a forefoot region and a midfoot region; and
a thickness of the sole plate from the inner side of the sole plate to the outer side of the sole plate is greater in the heel region than in the forefoot region.

9. The sole structure of claim 1, wherein:
the sole plate further includes a forefoot region and a midfoot region; and
a thickness of the heel support from the inner side of the heel support to the outer side of the heel support is greater than a thickness of the sole plate from the inner side of the sole plate to the outer side of the sole plate in the forefoot region.

10. The sole structure of claim 1, wherein:
the sole plate further includes a forefoot region and a midfoot region; and
at a cross-section extending along a longitudinal midline of the unitary, one-piece sole component, the sole plate has a concave curvature at the inner side of the sole plate and a convex curvature at the outer side of the sole plate in the forefoot region.

11. The sole structure of claim 1, wherein:
the sole plate further includes a forefoot region and a midfoot region; and
a minimum width of the unitary, one-piece sole component from a medial edge of the unitary, one-piece sole component to a lateral edge of the unitary, one-piece sole component in the midfoot region is at least 80 percent of a maximum width of the unitary, one-piece sole component from the medial edge of the unitary, one-piece sole component to the lateral edge of the unitary, one-piece sole component in the heel region.

12. The sole structure of claim 1, wherein the heel support defines a through hole extending from the inner side to the outer side.

13. The sole structure of claim 12, further comprising:
a receptacle mounted to the unitary, one-piece sole component at the through hole and defining an inlet at least partially aligned with the through hole.

14. The sole structure of claim 13, wherein the inlet is tapered.

15. The sole structure of claim 13, wherein the receptacle includes a flange extending around the through hole and against the outer side of the heel support.

16. The sole structure of claim 13, wherein the receptacle is included in a connector assembly, the connector assembly further including a retaining ring disposed around a neck of the receptacle at an inner side of the heel support, the neck extending through the through hole in the unitary, one-piece sole component.

17. The sole structure of claim 16, wherein the retaining ring and the neck of the receptacle include interfacing ramped surfaces.

18. The sole structure of claim 1, wherein:
the heel support defines a through hole extending from the inner side to the outer side;
the sole plate further includes a forefoot region and a midfoot region; and
the unitary, one-piece sole component is sufficiently rigid to transfer a force applied to the heel support at the through hole to the outer side of the sole plate in the forefoot region and/or the midfoot region.

19. A sole structure for an article of footwear, the sole structure comprising:
a unitary, one-piece sole component having an inner side facing a foot-receiving side of the sole structure and an outer side opposite from the inner side;
wherein the unitary, one-piece sole component defines a through hole extending from the inner side to the outer side; and
a receptacle mounted to the unitary, one-piece sole component at the through hole and defining an inlet at least partially aligned with the through hole.

20. The sole structure of claim 19, wherein the inlet is tapered.
